(19) United States
(12) Patent Application Publication
(10) Pub. No.: US 2023/0118543 A1
(43) Pub. Date: Apr. 20, 2023

(54) INTERMEDIATE TRANSFER MEMBER AND METHOD OF PRODUCTION THEREOF

(71) Applicant: HEWLETT-PACKARD DEVELOPMENT COMPANY, L.P., Spring, TX (US)

(72) Inventors: Tony Azzam, Nes Ziona (IL); Michael Kokotov, Nes Ziona (IL); Edith Beilis, Nes Ziona (IL); Sergey Inotaev, Nes Ziona (IL)

(21) Appl. No.: 17/911,102

(22) PCT Filed: Apr. 1, 2020
(86) PCT No.: PCT/US2020/026150

§ 371 Date: Sep. 12, 2022

(51) Int. Cl. G03G 15/16; C08L 83/04; C09D 183/04

(52) U.S. Cl. CPC G03G 15/162; C08L 83/04; C09D 183/04

(57) ABSTRACT

An intermediate transfer member for digital offset printing, comprising a cured silicone release layer formed by curing a curable silicone release formulation comprising a polyalkylsiloxane containing at least two vinyl groups; an at least partially fluorinated polyalkylsiloxane containing at least two vinyl groups; a polyalkylsiloxane cross-linker containing at least two Si-H bonds; and a catalyst or photoinitiator; wherein fluorine atoms provide at least 2.5 wt.% of the total weight of polyalkylsiloxane compounds. There is also described a method of producing an intermediate transfer member, and a curable silicone release formulation for an intermediate transfer member.

Digital offset printing apparatus typically include an intermediate transfer member (ITM) onto which an image is applied prior to transferring the image to a substrate. Current intermediate transfer members comprise a silicone release layer as the surface layer onto which the ink image is applied. Conventionally, silicone release layers are formed either by condensation curing or thermally assisted addition curing reactions.

### BRIEF DESCRIPTION OF THE FIGURES

FIG. 1 is a schematic illustration of an example of a digital offset printing apparatus, in this case, a liquid electrophotographic printing apparatus.

FIG. 2 is a schematic cross-sectional diagram of an example of an intermediate transfer member (ITM).

FIG. 3 is a schematic cross-sectional diagram of an example of an ITM structure.

FIG. 4 is a schematic cross-sectional diagram of an example of an ITM structure.

FIG. 5 shows a graph of the results of the background on blanket tests.

FIG. 6 shows a graph of the results of the release loss tests.

FIG. 7 shows a graph of the conformability test results.

### DETAILED DESCRIPTION

Before the intermediate transfer member and related aspects are disclosed and described, it is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a”, “an”, and “the” include plural referents unless the context clearly dictates otherwise.

As used herein, “UV-A light” or “UV-A radiation” refers to electromagnetic radiation having a wavelength in the range of about 315 nm to about 410 nm, for example about 320 nm to about 410 nm, about 340 nm to about 410 nm, about 340 nm to about 400 nm, about 360 nm to about 410 nm, about 365 nm to about 405 nm, about 365 to about 400 nm, or about 395 nm. The term “UV-A source” refers to is a source of UV-A radiation, for example UV-LED.

As used herein, “UV-A photoinitiator” refers to a photoinitiator or photo-catalyst that is activatable on exposure to “UV-A radiation”. Such UV-A photoinitiators are available commercially, an example is QPI-3100™ (available from Polymer-G, Israel) which is designed for curing under UV-A with a wavelength of 395 nm (UV-LED at 395 nm).

As used herein, the abbreviation “acac” refers to acetylacetonate.

As used herein, “electrophotographic ink composition” generally refers to an ink composition that is typically suitable for use in an electrophotographic printing process, sometimes termed an electrostatic printing process. The electrophotographic ink composition may include chargeable particles of the resin and the pigment dispersed in a liquid carrier, which may be as described herein.

The LEP inks referred to herein may comprise a colourant and a thermoplastic resin dispersed in a carrier liquid. In some examples, the thermoplastic resin may comprise an ethylene acrylic acid resin, an ethylene methacrylic acid resin or combinations thereof. In some examples, the electrostatic ink also comprises a charge director and/or a charge adjuvant. In some examples, the liquid electrostatic inks described herein may be ElectroInk® and any other Liquid Electro Photographic (LEP) inks developed by Hewlett-Packard Company.

As used herein, “liquid carrier”, “carrier liquid”, “carrier,” or “carrier vehicle” refers to the fluid in which resin, pigment, charge directors and/or other additives can be dispersed to form a liquid electrostatic ink or electrophotographic ink. The carrier liquid may include a mixture of a variety of different agents, such as surfactants, co-solvents, viscosity modifiers, and/or other possible ingredients. The carrier liquid can include or be a hydrocarbon, silicone oil, vegetable oil, and so forth. The carrier liquid can include, for example, an insulating, non-polar, non-aqueous liquid that can be used as a medium for the first and second resin components. The carrier liquid can include compounds that have a resistivity in excess of about 10⁹ ohm·cm. The carrier liquid may have a dielectric constant below about 5, in some examples below about 3. The carrier liquid may include hydrocarbons. In some examples, the carrier liquid comprises or consists of, for example, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol 0140™ (each sold by EXXON CORPORATION).

As used herein, “copolymer” refers to a polymer that is polymerized from at least two monomers.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

Unless otherwise stated, viscosity was measured using an AR-2000 model Rheometer from TAI (Thermal Analysis Instruments). The rheometer is used as a viscometer, by applying shear forces on the testing sample between two parallel plates. The sample is loaded between parallel plates at a known gap with an oscillatory (sinusoidal) shear profile of from 0.01 to 1,000 s⁻¹ at a temperature of 25° C. applied.

As used herein, “electrophotographic printing” or “electrostatic printing” generally refers to the process that provides an image that is transferred from a photoimaging plate either directly, or indirectly via an intermediate transfer member, to a print substrate. As such, the image is not substantially absorbed into the photoimaging plate on which it is applied. Additionally, “electrophotographic printers”, “electrophotographic printing apparatus”, “electrostatic printing apparatus” or “electrostatic printers” generally refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrostatic ink composition to an electric field, e.g., an electric field having a field gradient of 1000 V/cm or more, or in some examples, 1500 V/cm or more.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such a list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt% to about 5 wt%” should be interpreted to include not only the explicitly recited values of about 1 wt% to about 5 wt%, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

Unless otherwise stated, any feature described herein can be combined with any aspect or any other feature described herein.

In an aspect, there is provided an intermediate transfer member for digital offset printing. The intermediate transfer member for digital offset printing may comprise: a cured silicone release layer formed by curing a curable silicone release formulation comprising:
a polyalkylsiloxane containing at least two vinyl groups;
an at least partially fluorinated polyalkylsiloxane containing at least two vinyl groups;
a polyalkylsiloxane cross-linker containing at least two Si-H bonds; and
a catalyst or photoinitiator.

In some examples, the intermediate transfer member for digital offset printing may comprise:
a cured silicone release layer formed by curing a curable silicone release formulation comprising:
   a polyalkylsiloxane containing at least two vinyl groups;
   an at least partially fluorinated polyalkylsiloxane containing at least two vinyl groups;
   a polyalkylsiloxane cross-linker containing at least two Si-H bonds; and
   a catalyst or photoinitiator;
   wherein the fluorine atoms provide at least 2.5 wt.% of the total weight of polyalkylsiloxane compounds.

In another aspect, there is provided a method of producing an intermediate transfer member for digital offset printing. The method of producing an intermediate transfer member for digital offset printing may comprise:
applying onto an intermediate transfer member body a curable silicone release formulation; and
curing the curable silicone release formulation to form a cured silicone release layer;
wherein the curable silicone release formulation comprises:
   a polyalkylsiloxane containing at least two vinyl groups;
   an at least partially fluorinated polyalkylsiloxane containing at least two vinyl groups;
   a polyalkylsiloxane cross-linker containing at least two Si-H bonds; and
   a catalyst or photoinitiator.

In some examples, the method of producing an intermediate transfer member for digital offset printing may comprise:
applying onto an intermediate transfer member body a curable silicone release formulation; and
curing the curable silicone release formulation to form a cured silicone release layer;
wherein the curable silicone release formulation comprises:
   a polyalkylsiloxane containing at least two vinyl groups;
   an at least partially fluorinated polyalkylsiloxane containing at least two vinyl groups;
   a polyalkylsiloxane cross-linker containing at least two Si-H bonds; and
   a catalyst or photoinitiator;
   wherein fluorine atoms provide at least 2.5 wt.% of the total weight of polyalkylsiloxane compounds.

In a further aspect, there is provided a curable silicone release formulation for an intermediate transfer member of a digital offset printing apparatus. The curable silicone release formulation may comprise:
a polyalkylsiloxane containing at least two vinyl groups;
an at least partially fluorinated polyalkylsiloxane containing at least two vinyl groups;
a polyalkylsiloxane cross-linker containing at least two Si-H bonds; and
a catalyst or photoinitiator.

In some examples, the curable silicone release formulation may comprise:
a polyalkylsiloxane containing at least two vinyl groups;
an at least partially fluorinated polyalkylsiloxane containing at least two vinyl groups;
a polyalkylsiloxane cross-linker containing at least two Si-H bonds; and
a catalyst or photoinitiator;
wherein fluorine atoms provide at least 2.5 wt.% of the total weight of polyalkylsiloxane compounds.

During digital offset printing, for example, liquid electrophotographic (LEP) printing, the cured silicon release layer of intermediate transfer members are chemically and thermally degraded due to continuous exposure to carrier liquids (such as hydrocarbons) and repeated heating and cooling cycles throughout the printing process. Additionally, it is believed that during the transfer of LEP ink compositions from the photoimaging plate to the intermediate transfer member the release surface is damaged due to the formation of plasma during this transfer of ink. This effect is believed to accelerate the formation of memories on the silicone release layer, such as negative dot gain (NDG) and background on blanket. The incorporation of an at least partially fluorinated polyalkylsiloxane into the curable silicone release formulation has now been shown to avoid or at least mitigate at least one of these problems. Additionally, the incorporation of an at least partially fluorinated polyalkylsiloxane into the silicone release formulation has also been shown to improve the transferability of ink from the intermediate transfer member to the substrate, decreasing printing failures associated with residual ink on the ITM surface, such as the paper stuck on blanket (PTSB) failure.

### Digital Offset Printing Apparatus

In some examples, the digital offset printing apparatus may be any digital offset printing apparatus comprising an intermediate transfer member. In some examples, the digital offset printing apparatus may be a transfer inkjet printing apparatus or an electrostatic printing apparatus, for example, a dry toner electrostatic printing apparatus or a liquid electrostatic printing apparatus. In some examples, a transfer inkjet printing apparatus is an inkjet printing apparatus in which the ink is jetted onto an intermediate transfer member to form an image on the intermediate transfer member before the image is transferred from the intermediate transfer member to a substrate. In some examples, the digital offset printing apparatus is a liquid electrostatic (LEP) printing apparatus.

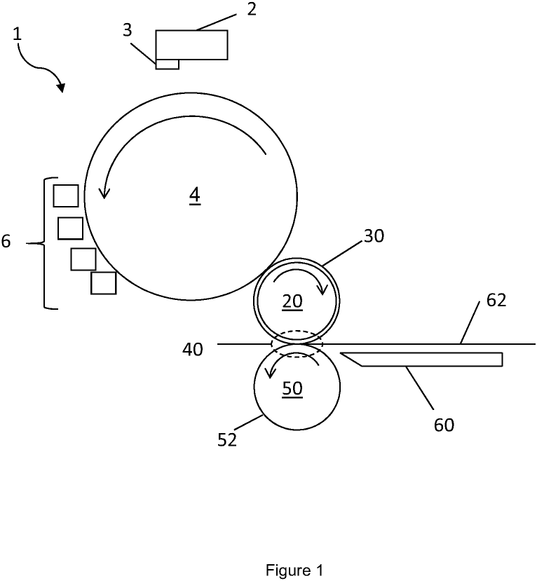

FIG. 1 shows a schematic illustration of an example of an LEP printing apparatus 1 and the use of an intermediate transfer member therein. An image, including any combination of graphics, text and images, is communicated to the LEP printing apparatus 1. The LEP printing apparatus includes a photo charging unit 2 and a photo-imaging cylinder 4. The image is initially formed on a photoimaging plate (also known as a photoconductive member), in this case in the form of photo-imaging cylinder 4, before being transferred to a cured silicone release layer 30 of the intermediate transfer member (ITM) 20 which is in the form of a roller (first transfer, T1), and then from the cured silicone release layer 30 of the ITM 20 to a print substrate 62 (second transfer, T2).

According to an illustrative example, the initial image is formed on rotating a photo-imaging cylinder 4 by a photo charging unit 2. Firstly, the photo charging unit 2 deposits a uniform static charge on the photo-imaging cylinder 4 and then a laser imaging portion 3 of the photo charging unit 2 dissipates the static charges in selected portions of the image area on the photo-imaging cylinder 4 to leave a latent electrostatic image. The latent electrostatic image is an electrostatic charge pattern representing the image to be printed. Liquid electrophotographic ink is then transferred to the photo-imaging cylinder 4 by a binary ink developer (BID) unit 6. The BID unit 6 presents a uniform film of liquid electrophotographic ink to the photo-imaging cylinder 4. The liquid electrophotographic ink contains electrically charged pigment particles which, by virtue of an appropriate potential on the electrostatic image areas, are attracted to the latent electrostatic image on the photo-imaging cylinder 4. The liquid electrophotographic ink does not adhere to the uncharged, non-image areas and forms a developed toner image on the surface of the latent electrostatic image. The photo-imaging cylinder 4 then has a single colour ink image on its surface.

The developed toner image is then transferred from the photo-imaging cylinder 4 to a cured silicone release layer 30 of an ITM 20 by electrical forces. The image is then dried and fused on the cured silicone release layer 30 of the ITM 20 before being transferred from the release layer 30 of the ITM 20 to a print substrate 62 disposed on an impression cylinder 50. The process may then be repeated for each of the coloured ink layers to be included in the final image.

The image is transferred from a photo-imaging cylinder 4 to an ITM 20 by virtue of an appropriate potential applied between the photo-imaging cylinder 4 and the ITM 20, such that the charged ink is attracted to the ITM 20.

Between the first and second transfers, the solid content of the developed toner image is increased and the ink is fused on to the ITM 20. For example, the solid content of the developed toner image deposited on the cured silicone release layer 30 after the first transfer is typically around 20%, by the second transfer the solid content of the developed toner image is typically around 80-90%. This drying and fusing is typically achieved by using elevated temperatures and airflow-assisted drying. In some examples, the ITM 20 is heatable.

The print substrate 62 is fed into the printing apparatus by a print substrate feed tray 60 and is disposed on an impression cylinder 50. As the print substrate 62 contacts the ITM 20, the single colour image is transferred to the print substrate 62.

To form a single colour image (such as a black and white image), one pass of the print substrate 62 through the impression cylinder 50 and the ITM 20 completes the image. For a multiple colour image, the print substrate 62 may be retained on the impression cylinder 50 and make multiple contacts with the ITM 20 as it passes through the nip 40. At each contact an additional colour plane may be placed on the print substrate 62.

### Intermediate Transfer Member

The intermediate transfer member may be termed an ITM herein for brevity.

The intermediate transfer member for digital offset printing may comprise a cured silicone release layer formed by curing a curable silicone release formulation comprising a polyalkylsiloxane containing at least two vinyl groups; an at least partially fluorinated polyalkylsiloxane containing at least two vinyl groups; a polyalkylsiloxane cross-linker containing at least two Si-H bonds; and a catalyst or photoinitiator. In some examples, the intermediate transfer member for digital offset printing may comprise a cured silicone release layer formed by curing a curable silicone release formulation comprising a polyalkylsiloxane containing at least two vinyl groups; an at least partially fluorinated polyalkylsiloxane containing at least two vinyl groups; a polyalkylsiloxane cross-linker containing at least two Si-H bonds; and a catalyst or photoinitiator; wherein fluorine atoms provide at least 2.5 wt.% of the total weight of polyalkylsiloxane compounds.

The ITM may comprise a supportive portion on which the cured silicone release layer is disposed. The supportive portion may be termed an intermediate transfer member body herein.

The ITM may have a base, for example, a metal base. The base may have a cylindrical shape. The base may form part of the supportive portion of the ITM.

The ITM may have a cylindrical shape; as such, the ITM may be suitable for use as a roller, for example, a roller in a digital offset printing apparatus.

The supportive portion of the ITM may comprise a layered structure disposed on the base of the ITM. The supportive portion may comprise a layer comprising a thermoplastic polyurethane.

The layered structure may comprise a compliant substrate layer, for example, a rubber layer or a layer comprising a thermoplastic polyurethane, on which the cured silicone release layer may be disposed. The compliant substrate layer may comprise a thermoplastic polyurethane layer or a rubber layer. The rubber layer may comprise an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ or FLS), a fluorocarbon rubber (FKM or FPM) or a perfluorocarbon rubber (FFKM).

The ITM may comprise a primer layer to facilitate bonding or joining of the curable silicone release layer to the compliant layer. The primer layer may form part of the supportive portion of the ITM, in some examples, the primer layer is disposed on the compliant substrate layer. In some examples, the primer layer may be any primer or primer layer described herein.

In some examples, the primer layer may comprise an organosilane, for example, an organosilane derived from an epoxysilane such as 3-glycidoxypropyltrimethoxysilane, a vinyl silane such as vinyltriethoxysilane or vinyltrimethoxysilane, an allyl silane, an acryloxysilane such as 3-methacryloxypropyltrimethoxysilane, or an unsaturated silane, and a catalyst such as a catalyst comprising titanium or platinum.

The primer layer may be formed from a curable primer layer. The curable primer layer may be applied to the compliant substrate layer of the supportive portion of the ITM before a curable silicone release formulation is applied to the supportive portion. The curable primer layer may comprise an organosilane and a catalyst, for example, a catalyst comprising titanium and/or a catalyst comprising platinum.

In some examples, the organosilane contained in the curable primer layer is selected from an epoxysilane, a vinyl silane, an allyl silane and an unsaturated silane.

The curable primer layer may comprise a first primer and a first catalyst, and a second primer and, in some examples, a second catalyst. The first primer and/or the second primer may comprise an organosilane. The organosilane may be selected from an epoxysilane, a vinyl silane, an allyl silane and an unsaturated silane.

In some examples, the first catalyst is a catalyst for catalysing a condensation cure reaction, for example, a catalyst comprising titanium. The first primer may be cured by a condensation reaction by the first catalyst. The second primer may be cured by a condensation reaction by the first catalyst.

In some examples, the second catalyst is a catalyst for catalysing an addition cure reaction.

The curable primer layer may be applied to the compliant layer as a composition containing the first and second primer and first and second catalyst.

In some examples the curable primer layer may be applied to the compliant layer as two separate compositions, one containing the first primer and first catalyst, the other containing the second primer and second catalyst. In some examples, the curable primer layer may be applied as two separate compositions, one containing the first primer (e.g., (3-glycidoxypropyl)trimethoxysilane and/or 3-methacryloxypropyltrimethoxysilane) and a photoinitiator (e.g., 2-hydroxy-2-methylpropiophenone), the other containing the second primer (e.g., (3-glycidoxypropyl)trimethoxysilane and/or vinyltrimethoxysilane or vinyltrethoxysilane) and a catalyst (e.g., titanium diisopropoxide bis-(acetylacetonate) and/or platinum divinyltetramethyldisiloxane).

In some examples, the ITM may comprise an adhesive layer for joining the compliant substrate layer to the base. The adhesive layer may be a fabric layer, for example, a woven or non-woven cotton, synthetic, combined natural and synthetic, or treated, for example, treated to have improved heat resistance, material.

The compliant substrate layer may be formed of a plurality of compliant layers. For example, the compliant substrate layer may comprise a compressible layer, a compliance layer and/or a conductive layer. A “conductive layer” may be a layer comprising electrically conductive particles. In some examples, any one or more of the plurality of compliant layers may comprise a thermoplastic polyurethane.

In some examples, the compressible layer is disposed on the base of the ITM. The compressible layer may be joined to the base of the ITM by the adhesive layer. A conductive layer may be disposed on the compressible layer. The compliance layer may then be disposed on the conductive layer, if present, or disposed on the compressible layer if no conductive layer is present. If the compressible layer and/or the compliance layer are partially conducting there may be no requirement for an additional conductive layer.

The compressible layer may have a large degree of compressibility. In some examples, the compressible layer may be 600 µm thick.

The compressible layer may comprise a thermoplastic polyurethane layer, a rubber layer which, for example, may comprise an acrylic rubber (ACM), a nitrile rubber (NBR), a hydrogenated nitrile rubber (HNBR), a polyurethane elastomer (PU), an EPDM rubber (an ethylene propylene diene terpolymer), or a fluorosilicone rubber (FLS). In some examples, the compressible layer may comprise carbon black to increase its thermal conductivity.

In some examples, the compressible layer includes small voids, which may be as a result of microspheres or blowing agents used in the formation of the compressible layer. In some examples, the small voids comprise about 40% to about 60% by volume of the compressible layer.

The compliance layer may comprise a thermoplastic polyurethane, a soft elastomeric material having a Shore A hardness value of less than about 65, or a Shore A hardness value of less than about 55 and greater than about 35, or a Shore A hardness value of between about 42 and about 45. In some examples, the compliance layer comprises a polyurethane, a thermoplastic polyurethane or an acrylic. Shore A hardness is determined by ASTM standard D2240.

In some examples, the compliance layer comprises an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (e.g., FMQ), a fluorocarbon rubber (e.g., FKM or FPM) or a perfluorocarbon rubber (e.g., FFKM). In some examples, the compliance layer comprises a thermoplastic polyurethane.

In an example the compressible layer and the compliance layer are formed from the same material.

The conductive layer may comprise a rubber, for example, an acrylic rubber (ACM), a nitrile rubber (NBR), a hydrogenated nitrile rubber (HNBR), or an EPDM rubber (an ethylene propylene diene terpolymer), and one or more conductive materials, including but not limited to carbon black or metallic particles. In some examples, the conductive layer may comprise a thermoplastic polyurethane and one or more conductive materials, including but not limited to carbon black or metallic particles.

In some examples, the compressible layer and/or the compliance layer may be made to be partially conducting with the addition of conducting particles, for example, conductive carbon black, metal particles or metal fibres. In some examples, where the compressible layer and/or the compliance layer are partially conducting there may be no requirement for an additional conductive layer.

In some examples, the intermediate transfer member comprises, in the following order:
a. a fabric layer;
b. a compressible layer, which may have voids therein;
c. a layer comprising electrically conductive particles;
d. a compliant layer;
e. a primer layer; and
f. a cured silicone release layer.

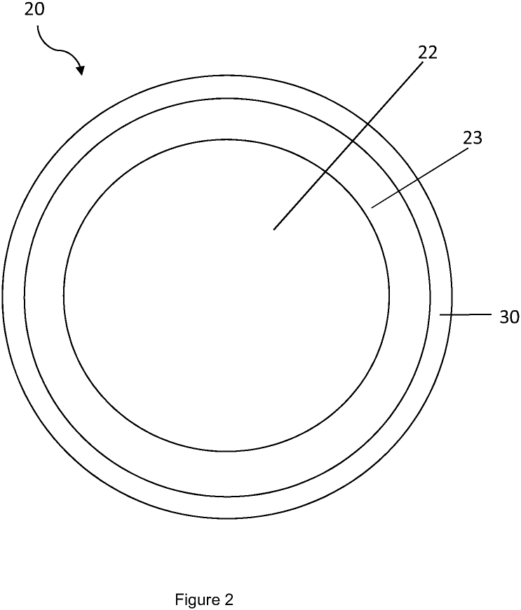

FIG. 2 is a cross-sectional diagram of an example of an ITM. The ITM includes a supportive portion comprising a base 22 and a substrate layer 23 disposed on the base 22. The base 22 may be a metal cylinder. The substrate layer 23 may comprise or be a thermoplastic polyurethane layer. The ITM 20 also comprises a cured silicone release layer 30 disposed on the substrate layer 23.

The substrate layer 23 may comprise or further comprise (if it also comprises a thermoplastic polyurethane layer) a rubber layer which may comprise an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (e.g., FMQ or FLS), a fluorocarbon rubber (e.g., FKM or FPM) or a perfluorocarbon rubber (e.g., FFKM). For example, the rubber layer may comprise an at least partly cured acrylic rubber, for example an acrylic rubber comprising a blend of acrylic resin Hi-Temp 4051 EP (Zeon Europe GmbH, Niederkasseler Lohweg 177, 40547 Düsseldorf, Germany) filled with carbon black pearls 130 (Cabot, Two Seaport Lane, Suite 1300, Boston, MA 02210, USA) and a curing system which may comprise, for example, NPC-50 accelerator (ammonium derivative from Zeon).

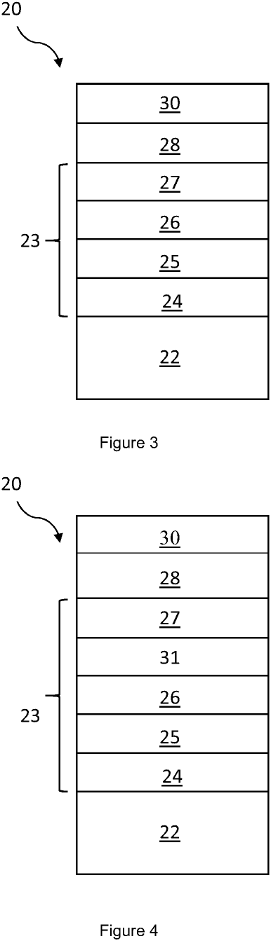

FIG. 3 shows a cross-sectional view of an example of an ITM having a substrate layer 23 comprising an adhesive layer 24 disposed between the base 22 and a compressible layer 25 for joining the compressible layer 25 of the substrate layer 23 to the base 22, a conductive layer 26 may be disposed on the compressible layer 25, and a compliance layer 27 (also called a soft compliant layer) may be disposed on the conductive layer 26. A primer layer 28 is disposed between the substrate layer 23 and the cured silicone release layer 30. At least one of the layers 24 to 27 may comprise a thermoplastic polyurethane.

FIG. 4 shows a cross-sectional view of an ITM having a substrate layer 23 comprising an adhesive layer 24 disposed between the base 22 and a compressible layer 25 for joining the compressible layer 25 of the substrate layer 23 to the base 22, a conductive layer 26 is disposed on the compressible layer 25, a layer comprising a thermoplastic polyurethane 31 is disposed on the conductive layer 26, and a compliance layer 27 (also called a soft compliant layer) is disposed on the conductive layer 26. The cured silicone release layer 30 is disposed on a primer layer 28, which is disposed on the compliance layer 27.

The adhesive layer may be a fabric layer, for example a woven or non-woven cotton, synthetic, combined natural and synthetic, or treated, for example, treated to have improved heat resistance, material. In an example the adhesive layer 23 is a fabric layer formed of NOMEX material having a thickness, for example, of about 200 µm.

The compressible layer 25 may be a rubber layer which, for example, may comprise an acrylic rubber (ACM), a nitrile rubber (NBR), a hydrogenated nitrile rubber (HNBR), a polyurethane elastomer (PU), an EPDM rubber (an ethylene propylene diene terpolymer), or a fluorosilicone rubber (FLS). The compressible layer may comprise a thermoplastic polyurethane.

The compliance layer 27 may comprise a soft elastomeric material having a Shore A hardness value of less than about 65, or a Shore A hardness value of less than about 55 and greater than about 35, or a Shore A hardness value of between about 42 and about 45. In some examples, the compliance layer 27 comprises a polyurethane or acrylic. In some examples, the compliance layer 27 comprises a thermoplastic polyurethane. Shore A hardness is determined by ASTM standard D2240. In some examples, the compliance layer comprises an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (e.g., FMQ), a fluorocarbon rubber (e.g., FKM or FPM) or a perfluorocarbon rubber (e.g., FFKM)

In an example, the compressible layer 25 and the compliance layer 27 are formed from the same material.

In some examples, the conductive layer 26 comprises a rubber, for example, an acrylic rubber (ACM), a nitrile rubber (NBR), a hydrogenated nitrile rubber (HNBR), or an EPDM rubber (an ethylene propylene diene terpolymer), and one or more conductive materials. In some examples, the conductive layer 26 comprises a thermoplastic polyurethane and one or more conductive materials. In some examples, the conductive layer 26 may be omitted, such as in some examples in which the compressible layer 25, the compliance layer 27, or the cured silicone release layer 30 are partially conducting. For example, the compressible layer 25 and/or the compliance layer 27 may be made to be partially conducting with the addition of conductive carbon black or metal fibres.

The primer layer 28 may be provided to facilitate bonding or joining of the release layer 30 to the substrate layer 23. The primer layer 28 may comprise an organosilane, for example, an organosilane derived from an epoxysilane such as 3-glycidylpropyl-trimethoxysilane, a vinyl silane such as vinyltriethoxysilane or vinyltrimethoxysilane, an allyl silane, an unsaturated silane or a (meth)acrylic silane, for example, 3-methacryloxypropyltrimethoxysilane, and a catalyst such as a catalyst comprising titanium or platinum.

In an example, a curable primer layer 28 is applied to a compliance layer 27 of a substrate layer 23, for example, to the outer surface of a compliance layer 27 made from an acrylic rubber. The curable primer may be applied using a rod coating process. The curable primer may comprise a first primer comprising an organosilane and a first catalyst comprising titanium, for example an organic titanate or a titanium chelate. In an example, the organosilane is an epoxysilane, for example, 3-glycidoxypropyltrimethoxysilane (available from ABCR GmbH & Co. KG, Im Schlehert 10 D-76187, Karlsruhe, Germany, product code SIG5840) and vinyltriethoxysilane (VTEO, available from Evonik, Kirschenallee, Darmstadt, 64293, Germany), vinyltrimethoxysilane, an allyl silane, an unsaturated silane or a (meth)acrylic silane, for example, 3-methacryloxypropyltrimethoxysilane. The first primer is curable by, for example, a condensation reaction. For example, the first catalyst for a silane condensation reaction may be an organic titanate such as Tyzor® AA75 (available from Dorf-Ketal Chemicals India Private Limited Dorf Ketal Tower, D’Monte Street, Orlem, Malad (W), Mumbai-400064, Maharashtra, INDIA.). The primer may also comprise a second primer comprising an organosilane, for example, a vinyl siloxane or a vinyl silane, for example, vinyl triethoxy silane, vinyltrimethoxysilane, an allyl silane, an unsaturated silane or a (meth)acrylic silane, for example, 3-methacryloxypropyltrimethoxysilane, and, in some examples, a second catalyst. The second primer may also be curable by a condensation reaction. The second catalyst, if present, may be different from the first catalyst and in some examples comprises platinum or rhodium. For example, the second catalyst may be a Karstedt catalyst with, for example, 9 wt.% platinum in solution (available from Johnson Matthey, 5th Floor, 25 Farringdon Street, London EC4A 4AB, United Kingdom) or a SIP6831.2 catalyst (available from Gelest, 11 East Steel Road, Morrisville, PA 19067, USA). This second primer may be cured by an addition reaction. The second catalyst in the second primer may be in contact with a pre-cure curable silicone release formulation applied onto the primer layer 28.

The curable primer layer applied to the substrate layer 23 may comprise a first primer and/or a second primer as described herein. The curable primer layer may be applied to the substrate layer 23 as two separate layers, one layer containing the first primer and the other layer containing the second primer.

The rubbers of the compressible layer 25, the conductive layer 26 and/or the compliance layer 27 of the substrate layer 23 may be uncured when the curable primer layer is applied thereon.

The silicone release layer 30 of the ITM 20 may be a cured silicone release layer that is formed by curing a curable silicone release formulation as described herein.

The silicone release layer 30 may be formed on the ITM by applying a layer of the curable silicone release formulation to a supportive portion of the ITM. For example, the silicone release layer may be applied to the substrate layer 23 or on top of a curable primer layer which has already been applied to the substrate layer 23. The curable primer layer and the silicone release layer may have been cured at the same time.

In some examples, once cured, the ITM comprises a cured silicone release layer 30 disposed on a substrate layer 23, or, if present, disposed on a primer layer 28.

In some examples, the curable silicone release formulation forms a silicone polymer matrix on curing, thus forming the cured silicone release layer.

### Curable Silicone Release Formulation

The curable silicone release formulation for an intermediate transfer member of a digital offset printing apparatus comprises a polyalkylsiloxane containing at least two vinyl groups; an at least partially fluorinated polyalkylsiloxane containing at least two vinyl groups; a polyalkylsiloxane cross-linker containing at least two Si-H bonds; and a catalyst or photoinitiator. In some examples, the curable silicone release formulation for an intermediate transfer member of a digital offset printing apparatus comprises a polyalkylsiloxane containing at least two vinyl groups; an at least partially fluorinated polyalkylsiloxane containing at least two vinyl groups; a polyalkylsiloxane cross-linker containing at least two Si-H bonds; and a catalyst or photoinitiator, wherein fluorine atoms provide at least 2.5 wt.% of the total weight of polyalkylsiloxane compounds.

In some examples, the curable silicone release formulation comprises a polyalkylsiloxane containing at least two vinyl groups; an at least partially fluorinated polyalkylsiloxane containing at least two vinyl groups; a polyalkylsiloxane cross-linker containing at least two Si-H bonds; a catalyst or photoinitiator, and conductive particles.

In some examples, the curable silicone release formulation comprises a polyalkylsiloxane containing at least two vinyl groups; an at least partially fluorinated polyalkylsiloxane containing at least two vinyl groups; a polyalkylsiloxane cross-linker containing at least two Si-H bonds; a catalyst or photoinitiator; and a thermal inhibitor. In some examples, the curable silicone release formulation comprises a polyalkylsiloxane containing at least two vinyl groups; an at least partially fluorinated polyalkylsiloxane containing at least two vinyl groups; a polyalkylsiloxane cross-linker containing at least two Si-H bonds; a catalyst or photoinitiator; conductive particles; and a thermal inhibitor.

In some examples, fluorine atoms provide at least 2.5 wt.% of the total weight of polyalkylsiloxane compounds in the curable silicone release formulation. The total weight of polyalkylsiloxane compounds is the sum of the weight of the a polyalkylsiloxane containing at least two vinyl groups, the at least partially fluorinated polyalkylsiloxane containing at least two vinyl groups and the polyalkylsiloxane cross-linker containing at least two Si-H bonds In some examples, fluorine atoms provide at least about 2.5 wt.%, for example, at least about 2.55 wt.%, at least about 2.6 wt.%, at least about 2.65 wt.%, at least about 2.7 wt.%, at least about 2.75 wt.%, at least about 2.8 wt.%, at least about 2.85 wt.%, at least about 2.9 wt.%, at least about 2.95 wt.%, at least about 3 wt.%, at least about 3.05 wt.%, at least about 3.1 wt.%, at least about 3.15 wt.%, at least about 3.2 wt.%, at least about 3.25 wt.%, at least about 3.3 wt.%, at least about 3.35 wt.%, at least about 3.4 wt.%, at least about 3.45 wt.%, at least about 3.5 wt.%, at least about 3.55 wt.%, at least about 3.6 wt.%, at least about 3.65 wt.%, at least about 3.7 wt.%, at least about 3.75 wt.%, at least about 3.8 wt.%, at least about 3.85 wt.%, at least about 3.87 wt.%, at least about 4 wt.%, at least about 4.5 wt.%, at least about 5 wt.%, at least about 5.5 wt.%, at least about 6 wt.%, at least about 6.5 wt.%, at least about 7 wt.%, at least about 7.5 wt.%, at least about 8 wt.%, at least about 8.5 wt.%, at least about 9 wt.%, at least about 9.5 wt.%, or at least about 10 wt.% of the total weight of polyalkylsiloxane compounds in the curable silicone release formulation.

In some examples, fluorine atoms provide up to 10 wt.% of the total weight of polyalkylsiloxane compounds in the curable silicone release formulation. In some examples, up to about 10 wt.%, for example, up to about 9.5 wt.%, up to about 9 wt.%, up to about 8.5 wt.%, up to about 8 wt.%, up to about 7.5 wt.%, up to about 7 wt.%, up to about 6.5 wt.%, up to about 6 wt.%, up to about 5.5 wt.%, up to about 5 wt.%, up to about 4.95 wt.%, up to about 4.9 wt.%, up to about 4.85 wt.%, up to about 4.8 wt.%, up to about 4.75 wt.%, up to about 4.7 wt.%, up to about 4.65 wt.%, up to about 4.6 wt.%, up to about 4.55 wt.%, up to about 4.5 wt.%, up to about 4.45 wt.%, up to about 4.4 wt.%, up to about 4.35 wt.%, up to about 4.3 wt.%, up to about 4.25 wt.%, up to about 4.2 wt.%, up to about 4.15 wt.%, up to about 4.1 wt.%, up to about 4.05 wt.%, up to about 4 wt.%, up to about 3.95 wt.%, up to about 3.9 wt.%, up to about 3.85 wt.%, up to about 3.8 wt.%, up to about 3.75 wt.%, up to about 3.7 wt.%, up to about 3.65 wt.%, up to about 3.6 wt.%, up to about 3.55 wt.%, up to about 3.5 wt.%, up to about 3.45 wt.%, up to about 3.4 wt.%, up to about 3.35 wt.%, up to about 3.3 wt.%, up to about 3.25 wt.%, up to about 3.2 wt.%, up to about 3.15 wt.%, up to about 3.1 wt.%, up to about 3.05 wt.%, up to about 3 wt.%, up to about 2.95 wt.%, up to about 2.9 wt.%, up to about 2.85 wt.%, up to about 2.8 wt.%, up to about 2.75 wt.%, up to about 2.7 wt.%, up to about 2.65 wt.%, up to about 2.6 wt.%, or up to about 2.55 wt.%, or up to about 2.5 wt.% of the total weight of polyalkylsiloxane compounds in the curable silicone release formulation.

In some examples, fluorine atoms provide from about 2.5 wt.% to about 10 wt.% of the total weight of polyalkylsiloxane compounds in the curable silicone release formulation, for example, from about 2.5 wt.% to about 10 wt.%, about 2.55 wt.% to about 9.5 wt.%, about 2.6 wt.% to about 9 wt.%, about 2.65 wt.% to about 8.5 wt.%, about 2.7 wt.% to about 8 wt.%, about 2.75 wt.% to about 7.5 wt.%, about 2.8 wt.% to about 7 wt.%, about 2.85 wt.% to about 6.5 wt.%, about 2.9 wt.% to about 6 wt.%, about 2.95 wt.% to about 5.5 wt.%, about 3 wt.% to about 5 wt.%, about 3.05 wt.% to about 4.5 wt.%, about 3.1 wt.% to about 4 wt.%, about 3.15 wt.% to about 3.87 wt.%, about 3.2 wt.% to about 4 wt.%, about 3.25 wt.% to about 6 wt.%, about 3.3 wt.% to about 4.5 wt.%, about 3.35 wt.% to about 4.1 wt.%, about 3.4 wt.% to about 4.2 wt.%, about 3.45 wt.% to about 4.3 wt.%, about 3.5 wt.% to about 4.8 wt.%, about 3.55 wt.% to about 4 wt.%, about 3.6 wt.% to about 5.3 wt.%, about 3.65 wt.% to about 3.9 wt.%, about 3.7 wt.% to about 4.2 wt.%, about 3.75 wt.% to about 3.89 wt.%, or about 3.8 wt.% to about 3.88 wt.% of the total weight of polyalkylsiloxane compounds in the curable silicone release formulation.

### At Least Partially Fluorinated Polyalkylsiloxane Containing at Least Two Vinyl Groups

In some examples, the curable release formulation comprises an at least partially fluorinated polyalkylsiloxane containing at least two vinyl groups. In some examples, the at least partially fluorinated polyalkylsiloxane containing at least two vinyl groups is selected from a linear at least partially fluorinated polyalkylsiloxane containing at least two vinyl groups, a branched at least partially fluorinated polyalkylsiloxane containing at least two vinyl groups, a cyclic at least partially fluorinated polyalkylsiloxane containing at least two vinyl groups and mixtures thereof. In some examples, the at least partially fluorinated polyalkylsiloxane containing at least two vinyl groups is a linear at least partially fluorinated polyalkylsiloxane containing at least two vinyl groups.

In some examples, the at least partially fluorinated polyalkylsiloxane containing at least two vinyl groups may be selected from at least partially fluorinated polyalkylsiloxanes containing two vinyl groups, at least partially fluorinated polyalkylsiloxanes containing three vinyl groups, or at least partially fluorinated polyalkylsiloxanes containing four vinyl groups. In some examples, the at least partially fluorinated polylalkylsiloxane contains two vinyl groups, for example, two terminal vinyl groups. In some examples, the vinyl groups are terminal vinyl groups, pendent vinyl groups or mixtures thereof. In some examples, the vinyl groups are terminal vinyl groups.

In some examples, the at least partially fluorinated polyalkylsiloxane containing at least two vinyl groups comprises a poly[(fluoroalkyl)alkylsiloxane-dialkylslioxane] copolymer comprising at least two vinyl groups. In some examples, the at least partially fluorinated polyalkylsiloxane containing at least two vinyl groups comprises a poly[(fluoroalkyl)alkylsiloxane-dialkylsiloxane] copolymer comprising two vinyl groups, for example, two terminal vinyl groups.

In some examples, the fluoroalkyl group is selected from linear, branched and cyclic fluoroalkyl groups. In some examples, the fluoroalkyl group is a linear fluoroalkyl group, for example, a linear C1 to C6 fluoroalkyl group. In some examples, the fluoroalkyl group is selected from monofluoroalkyl groups, difluoroalkyl groups, trifluoroalkyl groups, tetrafluoroalkyl groups, pentafluoroalkyl groups, hexafluoroalkyl groups, perfluoroalkyl groups and mixtures thereof. In some examples, the fluoroalkyl group is a trifluoroalkyl group. In some examples, the fluoroalkyl group is selected from mono-fluorinated C1 to C6 alkyl groups, di-fluorinated C1 to C6 alkyl groups, tri-fluorinated C1 to C6 alkyl groups, tetra-fluorinated C2 to C6 alkyl groups, penta-fluorinated C2 to C6 alkyl groups, hexa-fluorinated C3 to C6 alkyl groups, perfluorinated C1 to C6 groups and mixtures thereof. In some examples, the fluoroalkyl group a tri-fluorinated C1 to C6 alkyl group. In some examples, the fluoroalkyl group is selected from trifluoromethyl, trifluoroethyl, trifluoropropyl, trifluorobutyl, trifluoropentyl, trifluorohexyl and mixtures thereof. In some examples, the trifluoropropyl group is selected from a trifluoro-n-propyl (e.g., CF₃CH₂CH₂-), a trifluoroisopropyl (e.g., CF₃CH(CH₃)-) and mixtures thereof. In some examples, the fluoroalkyl group is trifluoro-n-propyl (for example, CF₃CH₂CH₂-). In some examples, the fluoroalkyl group comprises a CF₃- group, for example, CF₃-, a CF₃CH₂-, CF₃CF₂-, CF₃CH₂CH₂-, CF₃CF₂CH₂, and so forth. In some examples, the fluoroalkyl group comprises a CF₃ group attached to an alkyl chain, which may be considered to be a spacer.

In some examples, the fluoroalkyl group may be any fluoroalkyl group capable of mixing with a polydialkylsiloxane to form a solution that shows no phase separation.

In some examples, the alkyl group of the (fluoroalkyl)alkylsiloxane is selected from C1 to C6 alkyl groups. In some examples, the alkyl group of the (fluoroalkyl)alkylsiloxane is selected from linear C1 to C6 alkyl groups, branched C3 to C6 alkyl groups and cyclic C3 to C6 alkyl groups. In some examples, the alkyl group of the (fluoroalkyl)alkyl-siloxane is a linear C1 to C6 alkyl group. In some examples, the alkyl group of the (fluoroalkyl)alkylsiloxane is selected from methyl, ethyl, propyl, butyl, pentyl, hexyl and mixtures thereof. In some examples, the alkyl group of the (fluoroalkyl)alkylsiloxane is methyl.

In some examples, each alkyl group of the dialkylsiloxane is independently selected from C1 to C6 alkyl groups. In some examples, each alkyl group of the dialkylsiloxane is independently selected from linear C1 to C6 alkyl groups, branched C3 to C6 alkyl groups, and cyclic C3 to C6 alkyl groups. In some examples, each alkyl group of the dialkylsiloxane is independently selected from methyl, ethyl, propyl, butyl, pentyl, hexyl and mixtures thereof. In some examples, each alkyl group of the dialkylsiloxane is methyl.

In some examples, the poly[(fluoroalkyl)alkylsiloxane-dialkylslioxane] copolymer comprising at least two vinyl groups is a trifluoropropylalkylsiloxane-dialkylsiloxane copolymer comprising at least two vinyl groups, for example, a trifluoropropylmethylsiloxane-dimethylsiloxane copolymer comprising at least two vinyl groups.

In some examples, the at least partially fluorinated polyalkylsiloxane containing at least two vinyl groups comprises a vinyl-terminated at least partially fluorinated polyalkylsiloxane having the following formula:

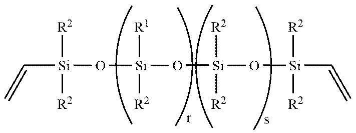

wherein R¹ is a perfluorinated alkyl group or a partially fluorinated alkyl group; each R² is independently an alkyl group; r is 1 or more; and s is 0 or more.

As used herein, a partially fluorinated alkyl group may be an alkyl group in which at least one hydrogen atom has been replaced by a fluorine atom. As used herein, a perfluorinated alkyl group may be an alkyl group in which every hydrogen atom has been replaced by a fluorine atom.

In some examples, R¹ is selected from fluorinated C1 to C6 alkyl groups comprising at least 1 fluorine atom, for example, at least 2 fluorine atoms, at least 3 fluorine atoms, or at least 4 fluorine atoms. In some examples, R¹ is selected from fluorinated C1 to C6 alkyl groups comprising 1, 2, 3 or 4 fluorine atoms. In some examples, R¹ is selected from fluorinated C1 to C6 alkyl groups comprising three fluorine atoms. In some examples, the C1 to C6 fluorinated alkyl group may be a linear C1 to C6 fluorinated alkyl group, a branched C3 to C6 fluorinated alkyl group or a cyclic C3 to C6 fluorinated alkyl group. In some examples, the fluorinated C1 to C6 alkyl group is selected from fluorinated methyl, fluorinated ethyl, fluorinated propyl, fluorinated butyl, fluorinated pentyl and fluorinated hexyl. In some examples, R¹ is selected from trifluoromethyl, trifluoroethyl (e.g., CF₃CH₂-), trifluoropropyl (e.g., CF₃CH₂CH₂- or CF₃CH(CH₃)-), trifluorobutyl (e.g., CF₃CH₂CH₂CH₂-), pentafluroethyl (CF₃CF₂-), pentafluoropropyl (e.g., CF₃CF₂CHᵣ), pentafluorobutyl (e.g., CF₃CF₂CH₂CH₂-), heptafluoropropyl (CF₃CF₂CF₂-), heptafluorobutyl (e.g., CF₃CF₂CF₂CH₂-) and mixtures thereof. In some examples, R¹ is selected from trifluromethyl, trifluoroethyl (e.g., CF₃CH₂-), trifluoropropyl (e.g., CF₃CH₂CH₂ or CF₃CH(CH₃)-) and mixtures thereof. In some examples, R¹ is trifluoropropyl. In some examples, trifluoropropyl is selected from CF₃CH₂CH₂-, CF₃CH(CH₃)- and mixtures thereof. In some examples, R¹ is CF₃CH₂CH₂-.

In some examples, each R² is the same or different. In some examples, each R² is the same. In some examples, each R² is independently selected from C1 to C6 alkyl groups and mixtures thereof. In some examples, each R² is independently selected from linear C1 to C6 alkyl groups, branched C3 to C6 alkyl groups and cyclic C3 to C6 alkyl groups. In some examples, each R² is independently selected from methyl, ethyl, propyl, butyl, pentyl and hexyl. In some examples, each R² is independently selected form methyl, ethyl and propyl. In some examples, each R² is methyl.

In some examples, r is 1 or more, for example, 2 or more, 5 or more, 10 or more, 50 or more, 60 or more, 70 or more, 75 or more, 80 or more, 85 or more, 100 or more, 150 or more, 200 or more, 250 or more, 300 or more, 350 or more, 400 or more, 450 or more, 500 or more, 550 or more, 600 or more, 650 or more, 700 or more, 750 or more, 800 or more, 850 or more, 900 or more, 950 or more, 1000 or more. In some examples, r is 1000 or less, for example, 950 or less, 900 or less, 850 or less, 800 or less, 750 or less, 700 or less, 650 or less, 600 or less, 550 or less, 500 or less, 450 or less, 400 or less, 350 or less, 300 or less, 250 or less, 200 or less, 150 or less, 100 or less, 85 or less, 80 or less, 75 or less, 70 or less, 60 or less, 50 or less, 10 or less, 5 or less, 2 or less. In some examples, r is 1 to 1000, for example, 10 to 950, 50 to 900, 60 to 850, 70 to 800, 75 to 750, 80 to 700, 85 to 650, 100 to 600, 150 to 550, 200 to 500, 10 to 250, 50 to 300, 70 to 350, 1 to 400.

In some examples, s is 0 or more, for example, 1 or more, 2 or more, 5 or more, 10 or more, 50 or more, 70 or more, 75 or more, 80 or more, 85 or more, 100 or more, 150 or more, 200 or more, 250 or more, 300 or more, 350 or more, 400 or more, 450 or more, 500 or more, 550 or more, 600 or more, 650 or more, 700 or more, 750 or more, 800 or more, 850 or more, 900 or more, 950 or more, 1000 or more. In some examples, s is 1000 or less, for example, 950 or less, 900 or less, 850 or less, 800 or less, 750 or less, 700 or less, 650 or less, 600 or less, 550 or less, 500 or less, 450 or less, 400 or less, 350 or less, 300 or less, 250 or less, 200 or less, 150 or less, 100 or less, 85 or less, 80 or less, 75 or less, 70 or less, 60 or less, 50 or less, 10 or less, 5 or less, 2 or less. In some examples, s is 1 to 1000, for example, 10 to 950, 50 to 900, 60 to 850, 70 to 800, 75 to 750, 80 to 700, 85 to 650, 100 to 600, 150 to 550, 200 to 500, 10 to 250, 50 to 300, 60 to 350, 70 to 400, 1 to 450.

In some examples, r is at least about 20% of (r + s), for example, at least about 25%, at least about 30%, at least about 35%, at least about 40%, at least about 45%, at least about 50% of (r + s). In some examples, r is up to about 60% of (r + s), for example, up to about 55%, up to about 50%, up to about 45%, up to about 40%, up to about 35%, up to about 30% of (r + s). In some examples, r is from about 20% of (r + s) to about 60% of (r + s), for example, from about 25% to about 55%, about 30% to about 50%, about 35% to about 45%, about 35% to about 40% of (r + s).

In some examples, the at least partially fluorinated polyalkylsiloxane containing at least two vinyl groups (for example, containing two vinyl groups, which may both be terminal vinyl groups) may be a random copolymer, a block copolymer, an alternating copolymer or a periodic copolymer. In some examples, the at least partially fluorinated polyalkylsiloxane containing at least two vinyl groups (for example, containing two vinyl groups, which may both be terminal vinyl groups) may be a random copolymer.

In some examples, the at least partially fluorinated polyalkylsiloxane containing at least two vinyl groups, for example, containing two vinyl groups, may have a weight average molecular weight of at least about 2000 g/mol, for example, at least about 3000 g/mol, at least about 4000 g/mol, at least about 5000 g/mol, at least about 6000, at least about 7000 g/mol, at least about 8000 g/mol, at least about 9000 g/mol, at least about 10,000 g/mol, at least about 15,000 g/mol, at least about 20,000 g/mol, at least about 25,000 g/mol, at least about 30,000 g/mol, at least about 35,000 g/mol, or at least about 40,000 g/mol. In some examples, the at least partially fluorinated polyalkylsiloxane containing at least two vinyl groups, for example, containing two vinyl groups, may have a weight average molecular weight of up to about 40,000 g/mol, for example, up to about 35,000 g/mol, up to about 30,000 g/mol, up to about 25,000 g/mol, up to about 20,000 g/mol, up to about 15,000 g/mol, up to about 10,000 g/mol, up to about 9000 g/mol, up to about 8000 g/mol, up to about 7000 g/mol, up to about 6000 g/mol, up to about 5000 g/mol, up to about 4000 g/mol, up to about 3000 g/mol, or up to about 2000 g/mol. In some examples, the at least partially fluorinated polyalkylsiloxane containing at least two vinyl groups, for example, containing two vinyl groups, may have a weight average molecular weight of from about 2000 g/mol to about 40,000 g/mol, for example, about 3000 g/mol to about 35,000 g/mol, about 4000 g/mol to about 30,000 g/mol, about 5000 g/mol to about 25,000 g/mol, about 6000 g/mol to about 20,000 g/mol, about 7000 g/mol to about 15,000 g/mol, about 8000 g/mol to about 10,000 g/mol, or about 6000 g/mol to about 9000 g/mol.

In some examples, the at least partially fluorinated polyalkylsiloxane containing at least two vinyl groups, for example, containing two vinyl groups, may have a kinematic viscosity at 25° C. of is at least about 1000 cSt, for example, at least about 2000 cSt, at least about 3000 cSt, at least about 4000 cSt, at least about 5000 cSt, at least about 6000 cSt, at least about 7000 cSt, at least about 8000 cSt, at least about 9000 cSt, at least about 10,000 cST, at least about 15,000 cSt, at least about 20,000 cSt, at least about 25,000 cSt. In some examples, the at least partially fluoroinated polyalkylsiloxane containing at least two vinyl groups, for example, containing two vinyl groups, may have a kinematic viscosity at 25° C. or up to about 25,000 cSt, for example, up to about 20,000 cSt, up to about 15,000 cSt, up to about 10,000 cSt, up to about 9000 cSt, up to about 8000 cSt, up to about 7000 cSt, up to about 6000 cSt, up to about 5000 cSt, up to about 4000 cSt, up to about 3000 cSt, up to about 2000 cSt, up to about 1000 cSt. In some examples, the at least partially fluorintated polyalkylsiloxane containing at least two vinyl groups, for example, containing two vinyl groups, may have a kinematic viscosity at 25° C. of from about 2000 cSt to about 25,000 cSt, for example, from about 3000 cSt to about 20,000 cSt, about 4000 cSt to about 15,000 cSt, about 5000 cSt to about 10,000 cSt, about 6000 cSt to about 9000 cSt, about 2000 cSt to about 8000 cSt, about 3000 cSt to about 7000 cSt, about 4000 cSt to about 6000 cSt, about 2000 cSt to about 5000 cSt about 7000 cSt, about 4000 cSt to about 6000 cSt, about 2000 cSt to about 5000 cSt. The kinematic viscosity is the Brookfield viscosity measured by using a Brookfield LV-DV2V Viscometer, with an LV-64 spindle, over a range of from 1 to 20 rpm and a range of shear rates of 1.7 to 34 s⁻¹ at a temperature of about 22° C.

In some examples, the at least partially fluorinated polyalkylsiloxane containing at least two vinyl groups, for example, containing two vinyl groups, may have a vinyl content of at least about 0.05 mmol/g, for example, at least about 0.1 mmol/g, at least about 0.15 mmol/g, at least about 0.2 mmol/g, at least about 0.25 mmol/g, at least about 0.3 mmol/g, at least about 0.35 mmol/g, at least about 0.4 mmol/g, at least about 0.45 mmol/g, or at least about 0.5 mmol/g. In some examples, the at least partially fluorinated polyalkylsiloxane containing at least two vinyl groups, for example, containing two vinyl groups, may have a vinyl content of up to about 0.5 mmol/g, for example, up to about 0.45 mmol/g, up to about 0.4 mmol/g, up to about 0.35 mmol/g, up to about 0.3 mmol/g, up to about 0.25 mmol/g, up to about 0.2 mmol/g, up to about 0.15 mmol/g, up to about 0.1 mmol/g, up to about 0.05 mmol/g. In some examples, the at least partially fluorinated polyalkylsiloxane containing at least two vinyl groups, for example, containing two vinyl groups, may have a vinyl content of from about 0.05 mmol/g to about 0.5 mmol/g, for example, about 0.1 mmol/g to about 0.45 mmol/g, about 0.15 mmol/g to about 0.4 mmol/g, about 0.2 mmol/g to about 0.35 mmol/g, or about 0.25 mmol/g to about 0.3 mmol/g.

Suitable examples of at least partially fluorinated polyakylsiloxanes containing at least two vinyl groups include FMV-4035 (available from Gelest) and SYL-OFF Q2-7785 (available from DOW).

### Polyalkylsiloxane Containing at Least Two Vinyl Groups

In some examples, the curable silicone release formulation comprises a polyalkylsiloxane containing at least two vinyl groups. In some examples, the polyalkylsiloxane containing at least two vinyl groups is selected from a linear polyalkylsiloxane containing at least two vinyl groups, a branched polyalkylsiloxane containing at least two vinyl groups, a cyclic polyalkylsiloxane containing at least two vinyl groups and mixtures thereof. In some examples, the polyalkylsiloxane containing at least two vinyl groups is a linear polyalkylsiloxane containing at least two vinyl groups.

In some examples, the polyalkylsiloxane containing at least two vinyl groups comprises a vinyl-terminated polyalkylsiloxane having the following formula:

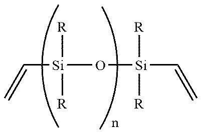

wherein each R is independently selected from C1 to C6 alkyl; and n is 1 or more.

In some examples, each R is independently selected from C1, C2, C3, C4, C5 and C6 alkyl. In some examples, each R is independently selected from methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R is independently selected from methyl, ethyl, n-propyl, isopropyl, n-butyl, sec-butyl, isobutyl, and tert-butyl. In some examples, each R is independently selected from methyl, ethyl, n-propyl, and isopropyl. In some examples, each R is the same. In some examples, each R is methyl.

In some examples, n is 1 or more, in some examples, 2 or more, in some examples, 5 or more, in some examples, 10 or more, in some examples, 50 or more, in some examples, 100 or more, in some examples, 150 or more, in some examples, 200 or more, in some examples, 250 or more, in some examples, 300 or more, in some examples, 350 or more, in some examples, 400 or more, in some examples, 450 or more, in some examples, 500 or more, in some examples, 550 or more, in some examples, 600 or more, in some examples, 650 or more, in some examples, 700 or more, in some examples, 750 or more, in some examples, 800 or more, in some examples, 850 or more, in some examples, 900 or more, in some examples, 950 or more, in some examples, 1000 or more. In some examples, n is 1000 or less, in some examples, 950 or less, in some examples, 900 or less, in some examples, 850 or less, in some examples, 800 or less, in some examples 750 or less, in some examples, 700 or less, in some examples, 650 or less, in some examples, 600 or less, in some examples, 550 or less, in some examples, 500 or less, in some examples, 450 or less, in some examples, 400 or less, in some examples, 350 or less, in some examples, 300 or less, in some examples, 250 or less, in some examples, 200 or less, in some examples, 150 or less, in some examples, 100 or less, in some examples, 50 or less, in some examples, 10 or less, in some examples, 5 or less, in some examples, 2 or less. In some examples, n is 1 to 1000, in some examples, 10 to 950, in some examples, 50 to 900, in some examples, 100 to 850, in some examples, 150 to 800, in some examples, 200 to 750, in some examples, 250 to 700, in some examples, 300 to 650, in some examples, 350 to 600, in some examples, 400 to 550, in some examples, 450 to 500.

In some examples, the vinyl-terminated polyalkylsiloxane has a dynamic viscosity at 25° C. of 250 mPa·s or more, in some examples, 300 mPa·s or more, in some examples, 350 mPa·s or more, in some examples, 400 mPa·s or more, in some examples, 450 mPa·s or more, in some examples, 500 mPa·s or more, in some examples, 550 mPa·s or more, in some examples 600 mPa·s or more, in some examples, 650 mPa·s or more, in some examples, 700 mPa·s or more, in some examples, about 750 mPa·s. In some examples, the vinyl-terminated polyalkylsiloxane has a dynamic viscosity at 25° C. or 750 mPa·s or less, in some examples, 700 mPa·s or less, in some examples, 650 mPa·s or less, in some examples, 600 mPa·s or less, in some examples, 550 mPa·s or less, in some examples, 500 mPa·s or less, in some examples, 450 mPa·s or less, in some examples, 400 mPa·s or less, in some examples, 350 mPa·s or less, in some examples, 300 mPa·s or less, in some examples, about 250 mPa·s. In some examples, the vinyl-terminated polyalkylsiloxane has a dynamic viscosity at 25° C. of 250 mPa·s to 750 mPa·s, in some examples, 300 mPa·s to 700 mPa·s, in some examples, 350 mPa·s to 650 mPa·s, in some examples, 400 mPa·s to 600 mPa·s, in some examples, 450 mPa·s to 550 mPa·s, in some examples, 450 mPa·s to 500 mPa·s.

In some examples, the vinyl-terminated polyalkylsiloxane may have a vinyl content of 0.05 mmol/g or more, in some examples, 0.06 mmol/g or more, in some examples, 0.07 mmol/g or more, in some examples, 0.08 mmol/g or more, in some examples, 0.09 mmol/g or more, in some examples, 0.1 mmol/g or more, in some examples, 0.11 mmol/g or more, in some examples, 0.12 mmol/g or more, in some examples, 0.13 mmol/g or more, in some examples, 0.14 mmol/g or more, in some examples, 0.15 mmol/g or more, in some examples, 0.16 mmol/g or more, in some examples, 0.17 mmol/g or more, in some examples, 0.18 mmol/g or more, in some examples, 0.19 mmol/g or more, in some examples, 0.2 mmol/g or more, in some examples, 0.3 mmol/g or more, in some examples, 0.4 mmol/g or more, in some examples, 0.5 mmol/g or more, in some examples, about 0.6 mmol/g. In some examples, the vinyl-terminated polyalkylsiloxane may have a vinyl content of 0.6 mmol/g or less, in some examples, 0.5 mmol/g or less, in some examples, 0.4 mmol/g or less, in some examples, 0.3 mmol/g or less, in some examples, 0.2 mmol/g or less, in some examples, 0.19 mmol/g or less, in some examples, 0.18 mmol/g or less, in some examples, 0.17 mmol/g or less, in some examples, 0.16 mmol/g or less, in some examples, 0.15 mmol/g or less, in some examples, 0.14 mmol/g or less, in some examples, 0.13 mmol/g or less, in some examples, 0.12 mmol/g or less, in some examples, 0.11 mmol/g or less, in some examples, 0.1 mmol/g or less, in some examples, 0.09 mmol/g or less, in some examples, 0.08 mmol/g or less, in some examples, 0.07 mmol/g or less, in some examples, 0.06 mmol/g or less, in some examples, about 0.05 mmol/g. In some examples, the vinyl-terminated polyalkylsiloxane may have a vinyl content of 0.05 mmol/g to 0.6 mmol/g, in some examples, 0.06 mmol/g to 0.5 mmol/g, in some examples, 0.07 mmol/g to 0.4 mmol/g, in some examples, 0.08 mmol/g to 0.3 mmol/g, in some examples, 0.09 mmol/g to 0.2 mmol/g, in some examples, 0.1 mmol/g to 0.19 mmol/g, in some examples, 0.11 mmol/g to 0.18 mmol/g, in some examples, 0.12 mmol/g to 0.17 mmol/g, in some examples, 0.13 mmol/g to 0.16 mmol/g, in some examples, 0.14 mmol/g to 0.15 mmol/g.

In some examples, the polyalkylsiloxane containing at least two vinyl groups comprises a pendent vinyl polyalkylsiloxane having the following formula:

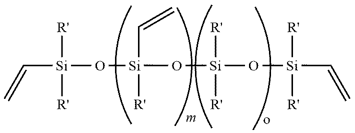

wherein each R′ is independently selected from C1 to C6 alkyl; m is 1 or more; and o is 0 or more.

In some examples, each R′ is independently selected from C1, C2, C3, C4, C5 and C6 alkyl. In some examples, each R′ is independently selected from methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R′ is independently selected from methyl, ethyl, n-propyl, isopropyl, n-butyl, sec-butyl, isobutyl, and tert-butyl. In some examples, each R′ is independently selected from methyl, ethyl, n-propyl, and isopropyl. In some examples, each R′ is the same. In some examples, each R′ is methyl.

In some examples, m is 1 or more, in some examples, 2 or more, in some examples, 5 or more, in some examples, 10 or more, in some examples, 50 or more, in some examples, 100 or more, in some examples, 150 or more, in some examples, 200 or more, in some examples, 250 or more, in some examples, 300 or more, in some examples, 350 or more, in some examples, 400 or more, in some examples, 450 or more, in some examples, 500 or more, in some examples, 550 or more, in some examples, 600 or more, in some examples, 650 or more, in some examples, 700 or more, in some examples, 750 or more, in some examples, 800 or more, in some examples, 850 or more, in some examples, 900 or more, in some examples, 950 or more, in some examples, 1000 or more. In some examples, m is 1000 or less, in some examples, 950 or less, in some examples, 900 or less, in some examples, 850 or less, in some examples, 800 or less, in some examples 750 or less, in some examples, 700 or less, in some examples, 650 or less, in some examples, 600 or less, in some examples, 550 or less, in some examples, 500 or less, in some examples, 450 or less, in some examples, 400 or less, in some examples, 350 or less, in some examples, 300 or less, in some examples, 250 or less, in some examples, 200 or less, in some examples, 150 or less, in some examples, 100 or less, in some examples, 50 or less, in some examples, 10 or less, in some examples 5 or less. In some examples, m is 1 to 1000, in some examples, 2 to 1000, in some examples, 10 to 950, in some examples, 50 to 900, in some examples, 100 to 850, in some examples, 150 to 800, in some examples, 200 to 750, in some examples, 250 to 700, in some examples, 300 to 650, in some examples, 350 to 600, in some examples, 400 to 550, in some examples, 450 to 500.

In some examples, o is 0 or more, in some examples, 1 or more, in some examples, 2 or more, in some examples, 5 or more, in some examples, 10 or more, in some examples, 50 or more, in some examples, 100 or more, in some examples, 150 or more, in some examples, 200 or more, in some examples, 250 or more, in some examples, 300 or more, in some examples, 350 or more, in some examples, 400 or more, in some examples, 450 or more, in some examples, 500 or more, in some examples, 550 or more, in some examples, 600 or more, in some examples, 650 or more, in some examples, 700 or more, in some examples, 750 or more, in some examples, 800 or more, in some examples, 850 or more, in some examples, 900 or more, in some examples, 950 or more, in some examples, 1000 or more. In some examples, o is 1000 or less, in some examples, 950 or less, in some examples, 900 or less, in some examples, 850 or less, in some examples, 800 or less, in some examples 750 or less, in some examples, 700 or less, in some examples, 650 or less, in some examples, 600 or less, in some examples, 550 or less, in some examples, 500 or less, in some examples, 450 or less, in some examples, 400 or less, in some examples, 350 or less, in some examples, 300 or less, in some examples, 250 or less, in some examples, 200 or less, in some examples, 150 or less, in some examples, 100 or less, in some examples, 50 or less, in some examples, 10 or less, in some examples, 5 or less. In some examples, o is 1 to 1000, in some examples, 2 to 1000, in some examples, 10 to 950, in some examples, 50 to 900, in some examples, 100 to 850, in some examples, 150 to 800, in some examples, 200 to 750, in some examples, 250 to 700, in some examples, 300 to 650, in some examples, 350 to 600, in some examples, 400 to 550, in some examples, 450 to 500

In some examples, the pendent vinyl polyalkylsiloxane has a dynamic viscosity at 25° C. of 2500 mPa·s or more, in some examples, 2550 mPa·s or more, in some examples, 2600 mPa·s or more, in some examples, 2650 mPa·s or more, in some examples, 2700 mPa·s or more, in some examples, 2750 mPa·s or more, in some examples, 2800 mPa·s or more, in some examples 2900 mPa·s or more, in some examples, 3000 mPa·s or more, in some examples, 3050 mPa·s or more, in some examples, 3100 mPa·s or more, in some examples, 3150 mPa·s or more, in some examples, 3200 mPa·s or more, in some examples, 3250 mPa·s or more, in some examples, 3300 mPa·s or more, in some examples, 3350 mPa·s or more, in some examples, 3400 mPa·s or more, in some examples, 3450 mPa·s or more, in some examples, about 3500 mPa·s. In some examples, the pendent vinyl polyalkylsiloxane has a dynamic viscosity at 25° C. or 3500 mPa·s or less, in some examples, 3450 mPa·s or less, in some examples, 3400 mPa·s or less, in some examples, 3350 mPa·s or less, in some examples, 3300 mPa·s or less, in some examples, 3250 mPa·s or less, in some examples, 3200 mPa·s or less, in some examples, 3150 mPa·s or less, in some examples, 3100 mPa·s or less, in some examples, 3050 mPa·s or less, in some examples, 3000 mPa·s or less, in some examples, 2950 mPa·s or less, in some examples, 2900 mPa·s or less, in some examples, 2850 mPa·s or less, in some examples, 2800 mPa·s or less, in some examples, 2750 mPa·s or less, in some examples, 2700 mPa·s or less, in some examples, 2650 mPa·s or less, in some examples, about 2500 mPa·s. In some examples, the pendent vinyl polyalkylsiloxane has a dynamic viscosity at 25° C. of 2500 mPa·s to 3500 mPa·s, in some examples, 2550 mPa·s to 3450 mPa·s, in some examples, 2600 mPa·s to 3400 mPa·s, in some examples, 2650 mPa·s to 3350 mPa·s, in some examples, 2700 mPa·s to 3300 mPa·s, in some examples, 2750 mPa·s to 3250 mPa·s, in some examples, 2800 mPa·s to 3200 mPa·s, in some examples, 2850 mPa·s to 3150 mPa·s, in some examples, 2900 mPa·s to 3100 mPa·s, in some examples, 2950 mPa·s to 3050 mPa·s, in some examples, 3000 mPa·s to 3050 mPa·s.

In some examples, the pendent vinyl polyalkylsiloxane may have a vinyl content of 0.1 mmol/g or more, 0.2 mmol/g or more, in some examples, 0.3 mmol/g or more, in some examples, 0.4 mmol/g or more, in some examples, 0.5 mmol/g or more, in some examples, 0.6 mmol/g or more, in some examples, 0.7 mmol/g or more, in some examples, 0.8 mmol/g or more, in some examples, 0.9 mmol/g or more, in some examples, 1 mmol/g or more, in some examples, 2 mmol/g or more. In some examples, the vinyl-terminated polyalkylsiloxane may have a vinyl content of 2 mmol/g or less, in some examples, 1 mmol/g or less, in some examples, 0.9 mmol/g or less, in some examples, 0.8 mmol/g or less, in some examples, 0.7 mmol/g or less, in some examples, 0.6 mmol/g or less, in some examples, 0.5 mmol/g or less, in some examples, 0.4 mmol/g or less, in some examples, 0.3 mmol/g or less, in some examples, 0.2 mmol/g or less, in some examples, 0.1 mmol/g or less. In some examples, the vinyl-terminated polyalkylsiloxane may have a vinyl content of 0.1 mmol/g to 2 mmol/g, in some examples, 0.2 mmol/g to 1 mmol/g, in some examples, 0.3 mmol/g to 0.9 mmol/g, in some examples, 0.4 mmol/g to 0.8 mmol/g, in some examples, 0.5 mmol/g to 0.7 mmol/g, in some examples, 0.3 mmol/g to 0.6 mmol/g.

In some examples, the polyalkylsiloxane containing at least two vinyl groups comprises a mixture of a vinyl-terminated polyalkylsiloxane having the following formula:

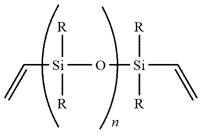

wherein each R is independently selected from C1 to C6 alkyl; and n is 1 or more; and a pendent vinyl polyalkylsiloxane having the following formula:

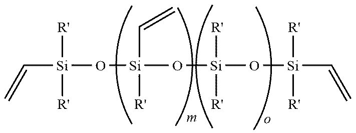

wherein each R′ is independently selected from C1 to C6 alkyl; m is 1 or more; and o is 0 or more. In some examples, the each R, each R′, n, m and o may be as defined above.

In some examples, the polyalkylsiloxane containing at least two vinyl groups comprises a vinyl-terminated polyalkylsiloxane and a pendent vinyl polyalkylsiloxane. In some examples, the polyalkylsiloxane containing at least two vinyl groups comprises a mixture of vinyl-terminated polyalkylsiloxane and pendent vinyl polyalkylsiloxane in a weight ratio of from 1:10 to 10:1. In some examples, the polyalkylsiloxane containing at least two vinyl groups comprises a mixture of vinyl-terminated polyalkylsiloxane and pendent vinyl polyalkylsiloxane in a weight ratio of from 1:9 to 9:1 mixture, in some examples, from 1:8 to 8:1, in some examples, from 1:7 to 7:1, in some examples, from 1:6 to 6:1, in some examples, from 1:5 to 5:1, in some examples, from 1:4 to 4:1, in some examples, from 1:3 to 3:1, in some examples, from 1:2 to 2:1, in some examples, from 1:1 to 4:1, in some examples, from 1:1 to 2:1.

Suitable examples of the polyalkylsiloxane containing at least two vinyl groups include Polymer VS 50, Polymer VS 100, Polymer VS 200, Polymer VS 500, Polymer VS 1000, Polymer VS 200, Polymer RV 100, Polymer RV 200, Polymer RV 500, available from Evonik Industries. Other suitable examples include DMS-V00, DMS-V03, DMS-V05, DMS-V21, DMS-V22, DMS-V25, DMS-V31, DMS-V33, DMS-V34, DMS-V35, DMS-V41, DMS-V42, DMS-V43, DMS-V46, DMS-V51, and DMS-V52 from Gelest Inc., Stroofstrasse 27, Geb.2901, 65933 Frankfurt am Main, Germany).

### Polyalkylsiloxane Cross-Linker Containing at Least Two Si-H Bonds

In some examples, the curable silicone release formulation comprises a polyalkylsiloxane cross-linker containing at least two Si-H bonds. In some examples, the polyalkylsiloxane cross-linker is selected from a linear polyalkylsiloxane cross-linker, a branched polyalkylsiloxane cross-linker and a cyclic polyalkylsiloxane cross-linker. In some examples, the polyalkylsiloxane cross-linker containing at least two Si-H bonds is a linear polyalkylsiloxane cross-linker.

In some examples, the polyalkylsiloxane containing at least two Si-H bonds comprises a polyalkylsiloxane cross-linker having the following formula:

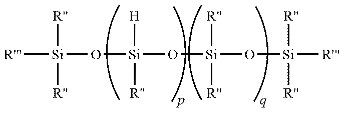

wherein each R″ is independently selected from C1 to C6 alkyl; each R‴ is independently selected from H and C1 to C6 alkyl; p is 2 or more; and q is 0 or more.

In some examples, each R″ is independently selected from C1, C2, C3, C4, C5 and C6 alkyl. In some examples, each R″ is independently selected from methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R″ is independently selected from methyl, ethyl, n-propyl, isopropyl, n-butyl, sec-butyl, isobutyl, and tert-butyl. In some examples, each R″ is independently selected from methyl, ethyl, n-propyl, and isopropyl. In some examples, each R″ is the same. In some examples, each R″ is methyl.

In some examples, each R‴ is independently selected from H, C1, C2, C3, C4, C5 and C6 alkyl. In some examples, each R‴ is independently selected from H, methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R‴ is independently selected from H, methyl, ethyl, n-propyl, isopropyl, n-butyl, sec-butyl, isobutyl, and tert-butyl. In some examples, each R‴ is independently selected from H, methyl, ethyl, n-propyl, and isopropyl. In some examples, each R‴ is the same. In some examples, each R‴ is H or methyl. In some examples, each R‴ is H. In some examples, each R‴ is methyl. In some examples, one R‴ is H and the second R‴ is methyl.

In some examples, R″ is methyl and R‴ is selected from H and methyl.

In some examples, p is 2 or more, in some examples, 3 or more, in some examples, 4 or more, in some examples, 5 or more, in some examples, 6 or more, in some examples, 7 or more, in some examples, 8 or more, in some examples, 9 or more, in some examples, in some examples, 10 or more, in some examples, 20 or more, in some examples, 50 or more. In some examples, p is 50 or less, in some examples, 20 or less, in some examples, 10 or less, in some examples, 9 or less, in some examples, 8 or less, in some examples, 7 or less, in some examples 6 or less, in some examples, 5 or less, in some examples, 4 or less, in some examples, 3 or less, in some examples, 2 or less. In some examples, p is 2 to 50, in some examples, 3 to 10, in some examples, 4 to 9, in some examples, 5 to 8, in some examples, 6 to 7.

In some examples, q is 0 or more, in some examples, 1 or more, in some examples, 2 or more, in some examples, 3 or more, in some examples, 4 or more, in some examples, 5 or more, in some examples, 6 or more, in some examples, 7 or more, in some examples, 8 or more, in some examples, 9 or more, in some examples, in some examples, 10 or more, in some examples, 20 or more, in some examples, 50 or more. In some examples, q is 50 or less, in some examples, 20 or less, in some examples, 10 or less, in some examples, 9 or less, in some examples, 8 or less, in some examples, 7 or less, in some examples 6 or less, in some examples, 5 or less, in some examples, 4 or less, in some examples, 3 or less, in some examples, 2 or less, in some examples, 1 or less. In some examples, q is 0 to 50, in some examples, 1 to 10, in some examples, 2 to 9, in some examples, 3 to 8, in some examples, 4 to 7, in some examples, 5 to 6.

In some examples, the polyalkylsiloxane cross-linker may be a random copolymer, a block copolymer, an alternating copolymer or a periodic copolymer. In some examples, the polyalkylsiloxane cross-linker may be a random copolymer.

In some examples, the polyalkylsiloxane cross-linker has a dynamic viscosity at 25° C. of 5 mPa·s or more, in some examples, 10 mPa·s or more, in some examples, 15 mPa·s or more, in some examples, 20 mPa·s or more, in some examples, 25 mPa·s or more, in some examples, 30 mPa·s or more, in some examples, 35 mPa·s or more, in some examples 40 mPa·s or more, in some examples, 45 mPa·s or more, in some examples, 50 mPa·s or more, in some examples, 55 mPa·s or more, in some examples, 60 mPa·s or more, in some examples, 65 mPa·s or more, in some examples, 70 mPa·s or more, in some examples, 75 or more, in some examples, about 80 mPa·s. In some examples, the polyalkylsiloxane cross-linker has a dynamic viscosity at 25° C. or 80 mPa·s or less, in some examples, 75 mPa·s or less, in some examples, 70 mPa·s or less, in some examples, 65 mPa·s or less, in some examples, 60 mPa·s or less, in some examples, 55 mPa·s or less, in some examples, 50 mPa·s or less, in some examples, 45 mPa·s or less, in some examples, 40 mPa·s or less, in some examples, 35 mPa·s or less, in some examples, 30 mPa·s or less, in some examples, 25 mPa·s or less, in some examples, 20 mPa·s or less, in some examples, 15 mPa·s or less, in some examples, about 10 mPa·s. In some examples, the polyalkylsiloxane cross-linker has a dynamic viscosity at 25° C. of 10 mPa·s to 80 mPa·s·s, in some examples, 15 mPa·s to 75 mPa·s, in some examples, 20 mPa·s to 70 mPa·s, in some examples, 25 mPa·s to 65 mPa·s, in some examples, 30 mPa·s to 60 mPa·s, in some examples, 35 mPa·s to 55 mPa·s, in some examples, 40 mPa·s to 50 mPa·s, in some examples, 40 mPa·s to 45 mPa·s.

In some examples, the polyalkylsiloxane cross-linker may have an Si-H content of 1 mmol/g or more, in some examples, 2 mmol/g or more, in some examples, 3 mmol/g or more, in some examples, 3.5 mmol/g or more, in some examples, 4 mmol/g or more, in some examples, 4.1 mmol/g or more, in some examples, 4.2 mmol/g or more, in some examples, 4.3 mmol/g or more, in some examples, 4.5 mmol/g or more, in some examples, 5 mmol/g or more, in some examples, 6 mmol/g or more, in some examples, 7 mmol/g or more, in some examples, about 8 mmol/g. In some examples, the polyalkylsiloxane cross-linker may have an Si-H content of 8 mmol/g or less, in some examples, 7 mmol/g or less, in some examples, 6 mmol/g or less, in some examples, 5 mmol/g or less, in some examples, 4.5 mmol/g or less, in some examples, 4.4 mmol/g or less, in some examples, 4.3 mmol/g or less, in some examples, 4.2 mmol/g or less, in some examples, 4.1 mmol/g or less, in some examples, 4 mmol/g or less, in some examples, 3.5 mmol/g or less, in some examples, 3 mmol/g or less, in some examples, 2 mmol/g or less, in some examples, about 1 mmol/g. In some examples, the polyalkylsiloxane cross-linker may have an Si-H content of 1 mmol/g to 8 mmol/g, in some examples, 2 mmol/g to 7 mmol/g, in some examples, 3 mmol/g to 6 mmol/g, in some examples, 3.5 mmol/g mmol/g to 5 mmol/g, in some examples, 4 mmol/g to 4.5 mmol/g, in some examples, 4.1 mmol/g to 4.4 mmol/g, in some examples, 4.2 mmol/g to 4.3 mmol/g.

Suitable examples of the polyalkylsiloxane cross-linker include Cross-linker 200, Cross-linker 210, Cross-linker 100, Cross-linker 101, Cross-linker 120, Cross-linker 125 or Cross-linker 190, available from Evonik Industries. Other suitable crosslinkers include HMS-031, HMS-071, HMS-082, HMS-013, and HMS-064 from Gelest Inc., Stroofstrasse 27, Geb.2901, 65933 Frankfurt am Main, Germany).

In some examples, the curable silicone release formulation comprises a ratio of polyalkylsiloxane containing cross-linker to the mixture of the at least partially fluorinated polyalkylsiloxane containing at least two vinyl groups and the polyalkylsiloxane containing at least two vinyl groups such that the mole ratio of hydride to vinyl is from 7 to 0.1. In some examples, the curable silicone release formulation comprises a ratio of polyalkylsiloxane containing cross-linker to the mixture of the at least partially fluorinated polyalkylsiloxane containing at least two vinyl groups and the polyalkylsiloxane containing at least two vinyl groups such that the mole ratio of hydride to vinyl is from 6.5 to 0.2, in some examples, 6 to 0.3, in some examples, 5.5 to 0.4, in some examples, 5 to 0.5, in some examples, 4.5 to 0.6, in some examples, 4 to 0.7, in some examples, 3.5 to 0.8, in some examples, 3.4 to 0.8, in some examples, 3.3 to 0.9, in some examples, 3.2 to 1, in some examples, 3.1 to 1.2, in some examples, 3 to 1.3, in some examples, 2.9 to 1.4, in some examples, 2.8 to 1.5, in some examples, 2.7 to 1.6, in some examples, 2.6 to 1.7, in some examples, 2.5 to 1.8, in some examples, 2.4 to 1.9, in some examples, 2.3 to 2, in some examples, 2.2 to 1.7, in some examples, 2.1 to 1.6. In some examples, the curable silicone release formulation comprises a ratio of polyalkylsiloxane containing cross-linker to the mixture of the at least partially fluorinated polyalkylsiloxane containing at least two vinyl groups and the polyalkylsiloxane containing at least two vinyl groups such that the mole ratio of hydride to vinyl is about 1.7, about 1.6, about 1.8, about 1.9, about 2, or about 2.1.

In some examples, the curable silicone release formulation comprises a weight ratio of polyalkylsiloxane containing cross-linker to the mixture of the at least partially fluorinated polyalkylsiloxane containing at least two vinyl groups and the polyalkylsiloxane containing at least two vinyl groups of from 0.5:10 to 1.5:10, for example, 0.6:10 to 1.4:10, 0.7:10 to 1.3:10, 0.8:10 to 1.2:10, 0.9:10 to 1.1:10, 1:10 to 1.5:10. In some examples, the curable silicone release formulation comprises a weight ratio of polyalkylsiloxane containing cross-linker to the mixture of the at least partially fluorinated polyalkylsiloxane containing at least two vinyl groups and the polyalkylsiloxane containing at least two vinyl groups of 1:10.

### Catalyst or Photoinitiator

In some examples, the catalyst or photoinitiator may initiate and/or catalyse the curing of the curable silicone release layer. In some examples, the catalyst or photoinitator may be a thermally activatable catalyst, a UV activatable catalyst, an IR activatable catalyst or a photoinitiator, for example, photoinitiator or photo-catalyst activatable on exposure to UV-A radiation. In some examples, catalyst or photoinitiator may be a thermally activatable catalyst, a photo-catalyst, or a photoinitiator. In some examples, the catalyst or photoinitiator may be selected from divinyl tetramethyl disiloxaneplatinum(0), [Pt(acac)₂] and UV-A photoinitiators, such as QPO-3100.

In some examples, the curable silicone release formulation may comprise, by total weight of the formulation, 20 ppm to 100 ppm of a catalyst or photoinitiator, for example, 25 ppm to 90 ppm, 30 ppm to 80 ppm, 35 ppm to 70 ppm, 35 ppm to 65 ppm, 40 ppm to 60 ppm, 45 ppm to 55 ppm, 50 ppm to 75 ppm based on the total amount of vinyl-containing polyalkylsiloxanes.

### Thermal Inhibitor

In some examples, the curable silicone release formulation comprises a thermal inhibitor. In some examples, the thermal inhibitor comprises an acetylenic alcohol or an alkanol. In some examples, the thermal inhibitor inhibits thermal curing of the at least partially fluorinated polyalkylsiloxane containing at least two vinyl groups, the polyalkylsiloxane containing at least two vinyl groups, and the polyalkylsiloxane cross-linker.

In some examples, the curable silicone release formulation comprises 0.001 wt.% to 10 wt.% thermal inhibitor, in some examples, 0.001 wt.% to 5 wt.%, in some examples, 0.01 wt.% to 2.5 wt.%, in some examples, 0.01 wt.% to 2 wt.%, in some examples, 0.1 wt.% to 1 wt.%, 0.5 wt.% to 5 wt.% thermal inhibitor based on the total amount of vinyl-containing polalkylsiloxane. In some examples, no thermal inhibitor is used.

Suitable examples of the thermal inhibitor include Inhibitor 600, Inhibitor 500 and Inhibitor 400 from Evonik. Other suitable thermal inhibitors include 1,3-divinyltetramethyldisiloxane(C₈H₁₈OSi₂) and 1,3,5,7-tetravinyl-1,3,5,7-tetramethylcyclotetrasiloxane (C₁₂H₂₄O₄Si₄), both from Gelest Inc.

### Conductive Particles

The curable silicone release formulation may comprise conductive particles. In some examples, the conductive particles may be electrically conductive particles. In some examples, the conductive particles may be carbon black particles.

In some examples, the curable silicone release formulation may comprise 0.01 wt.% to 10 wt.% conductive particles, in some examples, 0.05 wt.% to 9 wt.%, in some examples, 0.1 wt.% to 8 wt.%, in some examples, 0.25 wt.% to 7 wt.%, in some examples, 0.3 wt.% to 6 wt.%, in some examples, 0.4 wt.% to 5 wt.%, in some examples, 0.5 wt.% to 4 wt.%, in some examples, 0.6 wt.% to 3 wt.%, in some examples, 0.7 wt.% to 2.5 wt.%, in some examples, 0.75 wt.% to 2 wt.%, in some examples, 0.8 wt.% to 1.5 wt.%, in some examples 1 wt.% to 2 wt.%, and in some examples 1 wt.% to 1.5 wt.% conductive particles by total weight of the formulation.

In some examples, the curable silicone release formulation comprises greater than 0.8 wt.% conductive particles, for example, carbon black, greater than 1 wt.% conductive particles. In some examples, the curable silicone release formulation comprises at least 1.1 wt.% conductive particles by total weight of the formulation, for example at least 1.2 wt.%, at least 1.3 wt.%, at least 1.4 wt%, or at least 1.5 wt.%.

Suitable examples of the conductive particles include carbon black particles from AkzoNobel under the name Ketjenblack® EC600JD.

### Primer

In some examples, the ITM may comprise a primer. In some examples, the primer is applied to the compliant substrate layer of the supportive portion of the ITM before the curable silicone release formulation is applied to the supportive portion. In some examples, the primer forms a primer layer of the ITM. In some examples, the primer may be applied to an uncured compliant soft layer. In some examples, the primer may be applied to a cured compliant soft layer

In some examples, the primer layer may comprise an organosilane, for example, an organosilane derived from an epoxysilane such as 3-glycidoxypropyltrimethoxysilane, a vinyl silane such as vinyltriethoxysilane or vinyltrimethoxysilane, an allyl silane, an acryloxysilane such as 3-methacryloxypropyltrimethoxysilane, or an unsaturated silane, and a catalyst such as a catalyst comprising titanium or platinum.

The primer layer may be formed from a curable primer layer. The curable primer layer may be applied to the compliant substrate layer of the supportive portion of the ITM before a curable silicone release formulation is applied to the supportive portion. The curable primer layer may comprise an organosilane and a catalyst, for example, a catalyst comprising titanium and/or a catalyst comprising platinum.

In some examples, the organosilane contained in the curable primer layer is selected from an epoxysilane, a vinyl silane, an allyl silane and an unsaturated silane.

The curable primer layer may comprise a first primer and a first catalyst, and a second primer and, in some examples, a second catalyst. The first primer and/or the second primer may comprise an organosilane. The organosilane may be selected from an epoxysilane, a vinyl silane, an allyl silane and an unsaturated silane.

In some examples, the first catalyst is a catalyst for catalysing a condensation cure reaction, for example, a catalyst comprising titanium. The first primer may be cured by a condensation reaction by the first catalyst. The second primer may be cured by a condensation reaction by the first catalyst.

In some examples, the second catalyst is a catalyst for catalysing an addition cure reaction.

The curable primer layer may be applied to the compliant layer as a composition containing the first and second primer and first and second catalyst.

In some examples, only one primer is used. If only one primer is used, the primer may be the first primer formulation or the second primer formulation described herein. In some examples, only one primer is used, which comprises the second primer formulation described herein.

### First Primer Formulation

A first primer layer, which may also be referred to as a radiation curable or radiation cured primer layer, may be provided on the outer surface of the ITM body. The first primer layer may facilitate bonding or joining of the curable silicone release layer to the ITM body. The first primer layer may be formed from a radiation curable primer. The radiation curable primer may be applied by using a rod coating process or gravure coating process.

In some examples, the radiation curable primer is cured by UV light. The radiation curable primer may comprise a cross-linking compound capable of cross-linking to the outer surface of the layer of the ITM body on which it is disposed when irradiated with UV light. In some examples, the curable primer may comprise a functional organosilane. In some examples, the organosilane contained in the curable primer layer is selected from an epoxysilane, a vinyl silane, an allyl silane and an unsaturated silane, for example an acrylate functional silane, a methacrylate functional silane, an epoxysilane and mixtures thereof.

In some examples, the functional organosilane compound comprises, for example, a methacryloxypropyl trimethoxysilane, such as Dynasylan® MEMO™ (3-methacryloxypropyltrimethoxysilane) available from Degussa, AG of Piscataway, N.J.

In some examples, an epoxysilane is used in the first primer. In some examples, an epoxysilane, such as 3-glycidoxypropyl trimethoxysilane (available from ABCR GmbH & Co. KG) is used.

In some examples, the radiation curable primer comprises a photoinitiator to facilitate cross-linking of the functional organosilane to itself and with the surface of the layer of the ITM body on which it is disposed. In some examples, the photoinitiator includes, but is not limited to, α-hydroxyketones, α-aminoketones, benzaldimethyl-ketal, and mixtures thereof. In one example, the photoinitiator can comprise Darocur® 1173™, available from BASF, which comprises 2-hydroxy 2-methyl 1-phenyl 1-propanone, CAS number 7473-98-5. Other suitable photoinitiators include, but are not limited to, Irgacure® 500™ (a 50/50 blend of 1-hydroxy-cyclohexyl phenyl ketone and benzophenone), Irgacure® 651™ (an α,α-dimethoxy α-phenyl acetophenone), Irgacure® 907™ (2-methyl-1-[4-(methylthio)phenyl]-2-(4-morpholinyl)-1-propanone) from BASF. Additionally, any other suitable photoinitiators may be used. Generally, the photoinitiator can comprise about 1 wt.% to about 20 wt.% of the total first primer composition. In one example, the photoinitiator can comprise about 1 wt.% to about 5 wt.% of the total first primer composition.

In some examples, the coating of the curable primer is applied onto the layer of the ITM body on which it is disposed at a layer thickness of 10 µm or less, for example, 5 µm or less, for example, 4 µm or less, for example, 3 µm or less, for example, 2 µm or less, for example, 1 µm or less, for example, 0.5 µm or less, for example, about 250 nm. In some examples, the coating of the curable primer is applied onto the layer of the ITM body on which it is disposed at a layer thickness of 250 nm or more, for example, 0.5 µm or more, for example, 1 µm or more, for example, 2 µm or more, for example, 4 µm or more, for example, 5 µm or more, for example, about 10 µm. In some examples, the coating of the curable primer is applied onto the layer of the ITM body on which it is disposed at a layer thickness of from 250 nm to 10 µm, for example, from 0.5 µm to 5 µm, for example, about 1 µm.

### Second Primer Formulation

In some examples, a second primer composition, which may also be referred to as a curable composition, is provided on the outer surface of the first primer already applied to the ITM body. In some examples, the curable composition is applied to the outer surface of the first primer after curing of the first primer by irradiation. The curable composition may be applied using a rod coating process or gravure coating. The second primer composition facilitates bonding of the curable silicone release layer to the ITM body layer via the first primer.

In some examples, the curable composition is thermally curable. In some examples, the curable composition comprises a reactive monomer with addition polymerisable groups and condensation polymerisable groups. In some examples, the curable composition comprises a functional silane. Examples of functional silanes that can be used in the curable composition include but are not limited to an epoxysilane, an amino functional silane, an alkylsilane, a vinyl silane, an allyl silane, an unsaturated silane, a non-functional dipodal silane (e.g., bis triethoxysilyl octane), and their condensed forms constituted by oligomers of the monomeric form of the silane.

In some examples, the functional silane comprises a hydrolysable portion. In some examples, the hydrolysable portion of the silane comprises an alkoxy group (e.g., alkoxysilane with an alkoxy group selected from the group consisting of methoxy, ethoxy, propoxy, isopropoxy, methoxyethoxy, and the like). In some examples, the functional silane comprises an epoxyalkyl alkoxysilane (e.g., glycidoxypropyl trimethoxysilane-silane Dynasilan GLYMO (Degussa). In some examples, the hydrolyzable group may also be an oxime group (e.g., methylethylketoxime group) or an acetoxy group. Another illustrative example of an organosilane useful in the second primer is a hydrolysable vinyl silane, for example vinyltriethoxysilane (VTEO, available from Evonik, Kirschenallee, Darmstadt, 64293, Germany), a hydrolysable allyl silane or a hydrolysable unsaturated silane. In some examples, the second primer may comprise (3-glycidoxypropyl)trimethoxysilane and/or vinyltrimethoxysilane. In some examples, the second primer may comprise (3-glycidoxypropyl)trimethoxysilane and/or vinyltriethoxysilane.

The curable composition may comprise first and second catalysts, which are different to each other. In some examples, the first and second catalysts catalyse different types of polymerisation reaction. In some examples, the first catalyst catalyses a condensation polymerisation reaction. In some examples, the second catalyst catalyses an addition polymerisation reaction. In some examples, the curable composition comprises first and second catalysts, with the first catalyst catalysing the curing of the curable composition and the second catalyst catalysing the curing of the curable silicone release formulation. In some examples, the first catalyst also catalyses the cross-linking of the curable composition to the radiation-cured first primer. In some examples, the second catalyst also catalyses the cross-linking of the curable composition to the curable silicone release formulation.

In some examples, the first catalyst component of the curable composition comprises a titanate or a tin catalyst, or, alternatively, comprises any suitable compound that is capable of catalysing a condensation curing reaction of the organosilane of the curable composition. In certain embodiments, the first catalyst comprises an organic titanate catalyst such as acetylacetonate titanate chelate, available as, for example, Tyzor® AA-75 from E.I. du Pont de Nemours and Company of Wilmington, Del.)

In some examples, the first catalyst comprises about 1 wt.% to 20 wt.% of the total primer layer. In some examples, the first catalyst comprises about 1 wt.% to 5 wt.% of the total primer layer. Without being bound by theory, it is believed that acetylacetonate titanate chelate (Tyzor® AA-75) initiates a condensation reaction between the first and second primer components, inducing adhesion between the first and second primers.

In some examples, the second catalyst comprises platinum, or any other catalyst capable of catalysing an addition cure curing reaction of the second primer or curable composition. In some examples, the second catalyst comprises platinum or rhodium. In some examples, the second catalyst comprises a Karstedt catalyst with for example 9 wt.% or 10 wt.% platinum in solution (available from Johnson Matthey, 5th Floor, 25 Farringdon Street, London EC4A 4AB, United Kingdom) or SIP6831.2 catalyst (available from Gelest, 11 East Steel Road, Morrisville, Pa. 19067, USA).

In some examples, the coating of the curable composition (second primer) is applied onto the cured primer layer (cured first primer layer) at a layer thickness of 10 µm or less, for example, 5 µm or less, for example, 4 µm or less, for example, 3 µm or less, for example, 2 µm or less, for example, 1 µm or less, for example, 0.5 µm or less, for example, about 250 nm. In some examples, the coating of the curable composition (second primer) is applied onto the cured primer layer (cured first primer layer) at a layer thickness of 250 nm or more, for example, 0.5 µm or more, for example, 1 µm or more, for example, 2 µm or more, for example, 4 µm or more, for example, 5 µm or more, for example, about 10 µm. In some examples, the coating of the curable composition (second primer) is applied onto the cured primer layer (cured first primer layer) at a layer thickness of from 250 nm to 10 µm, for example, from 0.5 µm to 5 µm, for example, about 1 µm.

### Method of Making the Curable Silicone Release Formulation

In some examples, an at least partially fluorinated polyalkylsiloxane containing at least two vinyl groups may be combined with a polyalkylsiloxane containing at least two vinyl groups, a polyalkylsiloxane cross-linker containing at least two Si-H bonds, and a catalyst or photoinitiator.

In some examples, an at least partially fluorinated polyalkylsiloxane containing at least two vinyl groups may be combined with a polyalkylsiloxane containing at least two vinyl groups, a polyalkylsiloxane cross-linker containing at least two Si-H bonds, a catalyst or photoinitiator and conductive particles.

In some examples, an at least partially fluorinated polyalkylsiloxane containing at least two vinyl groups may be combined with a polyalkylsiloxane containing at least two vinyl groups, a polyalkylsiloxane cross-linker containing at least two Si-H bonds, a catalyst or photoinitiator, conductive particles and a thermal inhibitor.

In some examples, an at least partially fluorinated polyalkylsiloxane containing at least two vinyl groups may be combined with a polyalkylsiloxane containing at least two vinyl groups. In some examples, conductive particles may be combined with the polyalkylsiloxane containing at least two vinyl groups before during or after combining of the at least partially fluorinated polyalkylsiloxane containing at least two vinyl groups with the polyalkylsiloxane containing at least two vinyl groups.

In some examples, a catalyst or photoinitiator may be combined with the polyalkylsiloxane containing at least two vinyl groups before, during or after combining of a polyalkylsiloxane containing at least two vinyl groups and conductive particles and/or before, during or after combining the at least partially fluorinated polyalkylsiloxane containing at least two vinyl groups, the polyalkylsiloxane containing at least two vinyl groups and the conductive particles.

In some examples, an at least partially fluorinated polyalkylsiloxane containing at least two vinyl groups is combined with the polyalkylsiloxane containing at least two vinyl groups and optionally, the conductive particles and/or the catalyst or photoinitiator, under high shear mixing. In some examples, a polyalkylsiloxane cross-linker is then added under further high shear mixing.

In some examples, an at least partially fluorinated polyalkylsiloxane containing at least two vinyl groups is combined with a polyalkylsiloxane containing at least two vinyl groups which is then combined with conductive particles and then a polyalkylsiloxane cross-linker containing at least two Si-H bonds is added.

In some examples, a polyalkylsiloxane containing at least two vinyl groups is combined with conductive particles and then this mixture is combined with an at least partially fluorinated polyalkylsiloxane containing at least two vinyl groups and then a polyalkylsiloxane cross-linker containing at least two Si-H bonds is added.

In some examples, the composition to which a photoinititator is to be added is protected from light, for example, by wrapping the container in aluminium foil or using a container formed from a light-proof material, before addition of the photoinititator.

In some examples, the high shear mixing is at 3,000 rpm or more, in some examples, 3,500 rpm or more, in some examples, 4,000 rpm or more, in some examples, 4,500 rpm or more, in some examples, 5,000 rpm or more, in some examples, 5,500 rpm or more, in some examples, 6,000 rpm or more, in some examples, 6,500 rpm or more, in some examples, 7,000 rpm or more, in some examples 7,500 rpm or more, in some examples, 8,000 rpm or more, in some examples, 8,500 rpm or more, in some examples, about 9,000 rpm. In some examples, the high shear mixing is at 9,000 rpm or less, in some examples, 8,500 rpm or less, in some examples, 8,000 rpm or less, in some examples, 7,500 rpm or less, in some examples, 7,000 rpm or less, in some examples, 6,500 rpm or less, in some examples, 6,000 rpm or less, in some examples, 5,500 rpm or less, in some examples, 5,000 rpm or less, in some examples, 4,500 rpm or less, in some examples, 4,000 rpm or less, in some examples, 3,500 rpm or less, in some examples, about 3,000 rpm. In some examples, the high shear mixing is at 3,000 rpm to 9,000 rpm, in some examples, 3,500 rpm to 8,500 rpm, in some examples, 4,000 rpm to 8,000 rpm, in some examples, 4,500 rpm to 7,500 rpm, in some examples, 5,000 rpm to 7,000 rpm, in some examples, 5,500 rpm to 6,500 rpm, in some examples, 6,000 rpm to 6,500 rpm.

In some examples, the curable silicone release formulation is stored in the dark.

### Method of Producing an Intermediate Transfer Member

In an aspect, there is provided a method of producing an intermediate transfer member for digital offset printing. In some examples, the method of producing an intermediate transfer member for digital offset printing may comprise applying onto an intermediate transfer member body a curable silicone release formulation; and curing the curable silicone release formulation to form a cured silicone release layer. In some examples, the curable silicone release layer formulation may be any curable silicone release formulation described herein. In some examples, the curable silicone release formulation comprises a polyalkylsiloxane containing at least two vinyl groups; an at least partially fluorinated polyalkylsiloxane containing at least two vinyl groups; a polyalkylsiloxane cross-linker containing at least two Si-H bonds; and a catalyst or photoinitiator. In some examples, fluorine atoms provide at least 2.5 wt.% of the total weight of polyalkylsiloxane compounds.

In some examples, the method comprises applying onto an intermediate transfer member body a curable silicone release formulation. The intermediate transfer member body may comprise one or more of a metal base, a fabric layer, a compressible layer and a conductive layer as described herein, with the curable silicone release formulation being applied to the conductive layer. In some examples, the layer comprising the curable silicone release formulation is as described herein.

In some examples, the curable silicone release formulation is applied onto the ITM body by extrusion, calendering, lamination, gravure coating, rod coating, flexo coating, screen coating, spray coating, gravure coating, roll coating, reverse roll coating, gap coating, slot die coating, immersion coating, curtain coating, air knife coating, flood coating, lithography, or combinations thereof. Using these methods, the curable silicone release formulation can be processed in a straightforward manner with or without the use of solvents.

In some examples, the curable silicone release formulation is applied onto the ITM body at a gravure volume of 5 cm²/m³ or more, in some examples, 10 cm²/m³ or more, in some examples, 11 cm²/m³ or more, in some examples, 12 cm²/m³ or more, in some examples, 13 cm²/m³ or more, in some examples, 14 cm²/m³ or more, in some examples, 15 cm²/m³ or more, in some examples, 20 cm²/m³ or more. In some examples, the curable silicone release formulation is applied onto the ITM body at a gravure volume of 20 cm²/m³ or less, in some examples, 15 cm²/m³ or less, in some examples, 14 cm²/m³ or less, in some examples, 13 cm²/m³ or less, in some examples, 12 cm²/m³ or less, in some examples, 11 cm²/m³ or less, in some examples, 10 cm²/m³ or less, in some examples, 5 cm²/m³ or less. In some examples, the curable silicone release formulation is applied onto the ITM body at a gravure volume of 5 cm²/m³ to 20 cm²/m³, in some examples, 10 cm²/m³ to 15 cm²/m³, in some examples, 11 cm²/m³ to 14 cm²/m³, in some examples, 12 cm²/m³ to 14 cm²/m³, in some examples, 13 cm²/m³ to 14 cm²/m³.

The method may comprise applying a coating of a primer, optionally a radiation curable primer, onto the ITM body. In some examples, the coating of a radiation curable primer is applied using gravure coating, calendering, rod coating, flexo coating, screen coating, spray coating, gravure coating, roll coating, reverse roll coating, gap coating, slot die coating, immersion coating, curtain coating, air knife coating, flood coating, lithography, or combinations thereof.

In some examples, the coating of the primer, optionally, the radiation curable primer, is applied onto the ITM at a layer thickness as described herein. In some examples, the composition of the radiation curable primer is as described above.

The method may comprise irradiating the coating of radiation curable primer (for example, the first primer) to provide a coating of cured primer. In some examples, the coating of radiation curable primer is irradiated with light having a wavelength that corresponds to the optimal wavelength for the photoinitiator. In some examples, the step of irradiating comprises irradiating the coating of radiation curable primer using UV irradiation. The duration of the irradiation will depend on the power rating of the radiation source being used and the actual power supplied. In some examples, irradiating the coating of radiation curable primer comprises irradiating in order to fully cure the primer. In some examples, irradiating the coating of radiation curable primer comprises irradiating in order to at least partially cure the primer. In some examples, the radiation-cured primer composition comprises a polymerisation product of an epoxysilane, a vinyl silane, an allyl silane, an acrylate functional silane, and a methacrylate functional silane, and mixtures thereof.

The method may comprise applying onto the coating of cured primer a second primer in the form of a curable composition comprising first and second catalysts. In some examples, the curable composition is applied using gravure coating, calendering, rod coating, flexo coating, screen coating, spray coating, gravure coating, roll coating, reverse roll coating, gap coating, slot die coating, immersion coating, curtain coating, air knife coating, flood coating, lithography, or combinations thereof. In some examples, the composition of the curable composition is as described herein.

In some examples, the coating of the curable composition (second primer) is applied onto the radiation cured primer layer at a layer thickness as described herein.

The method may comprise applying onto the curable composition a curable silicone release formulation. The curable silicone release formulation may be applied onto the curable composition before any substantial curing of the curable composition has taken place. In some examples, the curable silicone release formulation is applied onto the curable composition at a layer thickness as described herein.

The method may comprise simultaneously curing the curable primer composition and the curable silicone release formulation.

In some examples, curing the curable silicone release formulation occurs by exposing the curable silicone release formulation to heat or irradiation, for example, UV-A irradiation.

In some examples, the method comprises curing the curable silicone release formulation by irradiating the curable silicone release formulation for 1 second or more, in some examples, 2 seconds or more, in some examples, 3 seconds or more, in some examples, 4 seconds or more, in some examples, 5 seconds or more, in some examples, 6 seconds or more, in some examples, 7 seconds or more, in some examples, 8 seconds or more, in some examples, 9 seconds or more, in some examples, 10 seconds or more, in some examples, 15 seconds or more, in some examples, 20 seconds or more. In some examples, the method comprises curing the curable silicone release formulation by irradiating the curable silicone release formulation for 20 seconds or less, in some examples, 10 seconds or less, in some examples, 9 seconds or less, in some examples 8 seconds or less, in some examples, 7 seconds or less, in some examples, 6 seconds or less, in some examples, 5 seconds or less, in some examples, 5 seconds or less, in some examples, 4 seconds or less, in some examples, 3 seconds or less, in some examples, 2 seconds or less, in some examples, 1 second or less. In some examples, the method comprises curing the curable silicone release formulation by irradiating the curable silicone release formulation for 1 second to 20 seconds, in some examples, 2 seconds to 10 seconds, in some examples, 3 seconds to 9 seconds, in some examples, 4 seconds to 8 seconds, in some examples, 5 seconds to 7 seconds, in some examples, 5 seconds to 6 seconds.

In some examples, the curable silicone release formulation passes the irradiation source, for example, at a speed of 1 m/min or more, in some examples, 2 m/min or more, in some examples, 3 m/min or more, in some examples, 4 m/min or more, in some examples, 5 m/min or more, in some examples, 6 m/min or more, in some examples, 7 m/min or more, in some examples, 8 m/min or more, in some examples, 9 m/min or more, in some examples, 10 m/min or more. In some examples, the curable silicone release formulation passes the irradiation source at a speed of 10 m/min or less, in some examples, 9 m/min or less, in some examples, 8 m/min or less, in some examples, 7 m/min or less, in some examples, 6 m/min or less, in some examples, 5 m/min or less, in some examples, 4 m/min or less, in some examples, 3 m/min or less, in some examples, 2 m/min or less, in some examples, 1 m/min or less. In some examples, the curable silicone release formulation passes the irradiation source at a speed of 1 m/min to 10 m/min, in some examples, 2 m/min to 9 m/min, in some examples, 2 m/min to 8 m/min, in some examples, 3 m/min to 7 m/min, in some examples, 4 m/min to 6 m/min, in some examples, 5 m/min to 6 m/min.

In some examples, the irradiation source is an LED UV lamp, a Hg UV lamp, a Xenon arc lamp, or a microwave UV lamp. In some examples, the Xenon arc lamp. It is also possible to use other sources that emit irradiation.

In some examples, after irradiating with irradiation, the intermediate transfer member is left at room temperature to ensure full curing of the curable silicone release layer prior to use in a digital offset printing apparatus. In some examples, after irradiating with irradiation, the intermediate transfer member is left at room temperature for 24 hours under ambient light to ensure full curing of the curable silicone release layer prior to use in a digital offset printing apparatus.

In some examples, curing the curable silicone release formulation comprises irradiating the curable silicone release layer with light and then heating the curable silicone release formulation. In some examples, after irradiating with irradiation, the intermediate transfer member is heated to ensure full curing of the curable silicone release layer. In some examples, heating of the ITM involves heating at greater than room temperature, for example heating at a temperature of about 40° C. or greater, about 50° C. or greater, about 60° C. or greater, about 80° C. or greater, about 100° C. or greater, for example about 120° C. In some examples, heating of the ITM involves heating at a temperature greater than room temperature to about 200° C., for example from about 40° C. to about 150° C. In some examples, the ITM is heated for at least 1 hour, for example about 2 hours.

In some examples, curing of the curable silicone release formulation comprise heating the curable silicone release formulation. In some examples, heating involves heating at greater than room temperature, for example, heating at a temperature of about 40° C. or greater, about 50° C. or greater, about 60° C. or greater, about 80° C. or greater, about 100° C. or greater, for example about 120° C. In some examples, heating involves heating at a temperature of from greater than room temperature to about 200° C., for example, from about 40° C. to about 190° C., about 50° C. to about 180° C., about 60° C. to about 170° C., about 70° C. to about 160° C., about 80° C. to about 150° C., about 90° C. to about 140° C., about 100° C. to about 130° C., or about 110° C. to about 120° C. In some examples, the heating is for at least 1 hour, for example, at least 1.5 hours, or at least 2 hours.

In some examples, the curable silicone release formulation is applied onto the ITM body, in some examples, onto the primer layer, for example, the second primer layer, with a layer thickness of 1 µm or more, for example, 1.5 µm or more, for example, 2 µm or more, for example, 3 µm or more, for example, 4 µm or more, for example, 5 µm or more, for example, 6 µm or more, for example, 7 µm or more, for example, 8 µm or more, for example, 9 µm or more, for example, 10 µm or more, for example, 11 µm or more, for example, 12 µm or more, for example, 13 µm or more, for example, 14 µm or more, for example, about 15 µm. In some examples, the curable silicone release formulation is applied onto the ITM body, in some examples, onto the primer layer, for example, the second primer layer, with a layer thickness of 15 µm or less, for example, 14 µm or less, for example, 13 µm or less, for example, 12 µm or less, for example, 11 µm or less, for example, 10 µm or less, for example, 9 µm or less, for example, 8 µm or less, for example, 7 µm or less, for example, 6 µm or less, for example, 5 µm or less, for example, 4 µm or less, for example, 3 µm or less, for example, 2 µm or less, for example, 1.5 µm or less, for example, about 1 µm. For example, the curable silicone release formulation is applied onto ITM body, in some examples, onto the primer layer, for example, the second primer layer, with a layer thickness of from 1 µm to 15 µm, for example, of from 1.5 µm to 12 µm, for example, of from 3 µm to 10 µm, for example, of from 5 µm to 9 µm.

Accordingly, there is also provided a digital offset printing apparatus comprising an intermediate transfer member, the intermediate transfer member comprising a cured silicone release layer comprising a cured curable silicone release formulation, the curable silicone release formulation comprising:
a polyalkylsiloxane containing at least two vinyl groups;
an at least partially fluorinated polyalkylsiloxane containing at least two vinyl groups;
a polyalkylsiloxane cross-linker containing at least two Si-H bonds; and
a catalyst or photoinitiator;
wherein fluorine atoms may provide at least 2.5 wt.% of the total weight of polyalkylsiloxane compounds.

Accordingly, there is also provided a digital offset printing apparatus comprising an intermediate transfer member, the intermediate transfer member comprising a cured silicone release layer formed by curing a curable silicone release formulation comprising:
a vinyl-terminated polyalkylsiloxane having the following formula:

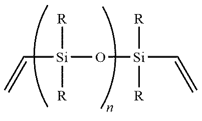

wherein
   each R is independently selected from C1 to C6 alkyl; and
   n is 1 or more;
a pendent vinyl polyalkylsiloxane having the following formula:

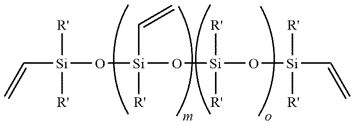

wherein
   each R′ is independently selected from C1 to C6 alkyl;
   m is 1 or more; and
   o is 0 or more;
an at least partially fluorinated polyalkylsiloxane containing at least two vinyl groups comprises a vinyl-terminated at least partially fluorinated polyalkylsiloxane having the following formula:

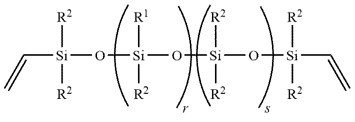

wherein
   R¹ is a partially fluorinated alkyl group;
   each R² is independently an alkyl group;
   r is 1 or more; and
   s is 0 or more.
a polyalkylsiloxane cross-linker having the following formula:

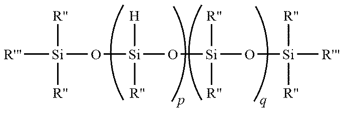

wherein
   each R″ is independently selected from C1 to C6 alkyl;
   each R‴ is independently selected from H and C1 to C6 alkyl;
   p is 2 or more; and
   q is 0 or more; and
a catalyst or photoinitiator;
wherein fluorine atoms may provide at least 2.5 wt.% of the total weight of polyalkylsiloxane compounds.

The digital offset printing apparatus may further comprise one or more print stations or printheads, a primer station and a radiation source, and be adapted, in use, to apply a primer to the intermediate transfer member; jet a radiation curable inkjet ink onto the primer to form a print image on the intermediate transfer member; and irradiate the image and primer to at least partially cure the radiation curable inkjet ink and the primer on the intermediate transfer member, and transferring the print image to a print substrate.

Accordingly, there is also provided a method of digital offset printing on a printing apparatus comprising an intermediate transfer member, the intermediate transfer member comprising a cured silicone release layer formed by curing a curable silicone release formulation comprising:
a polyalkylsiloxane containing at least two vinyl groups;
an at least partially fluorinated polyalkylsiloxane containing at least two vinyl groups;
a polyalkylsiloxane cross-linker containing at least two Si-H bonds; and
a catalyst or photoinitiator;
the printing method comprising generating on the intermediate transfer member a print image, and transferring the print image from the intermediate transfer member to a print substrate;
wherein fluorine atoms may provide at least 2.5 wt.% of the total weight of polyalkylsiloxane compounds.

Accordingly, there is also provided a method of digital offset printing on a printing apparatus comprising an intermediate transfer member, the intermediate transfer member comprising a cured silicone release layer formed by curing a curable silicone release formulation comprising:
a vinyl-terminated polyalkylsiloxane having the following formula:

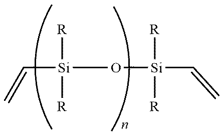

wherein
   each R is independently selected from C1 to C6 alkyl; and
   n is 1 or more;
a pendent vinyl polyalkylsiloxane having the following formula:

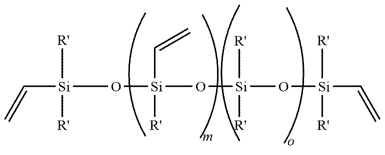

wherein
   each R′ is independently selected from C1 to C6 alkyl;
   m is 1 or more; and
   o is 0 or more
an at least partially fluorinated polyalkylsiloxane containing at least two vinyl groups comprises a vinyl-terminated at least partially fluorinated polyalkylsiloxane having the following formula:

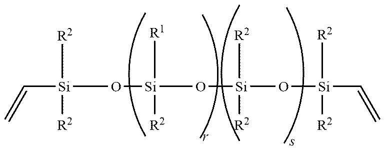

wherein
   R¹ is a partially fluorinated alkyl group;
   each R² is independently an alkyl group;
   r is 1 or more; and
   s is 0 or more;
a polyalkylsiloxane cross-linker having the following formula:

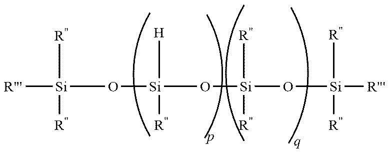

Wherein
   each R″ is independently selected from C1 to C6 alkyl;
   each R‴ is independently selected from H and C1 to C6 alkyl;
   p is 2 or more; and
   q is 0 or more; and
a catalyst or photoinitiator;
the printing method comprising generating on the intermediate transfer member a print image, and transferring the print image from the intermediate transfer member to a print substrate; wherein fluorine atoms may provide at least 2.5 wt.% of the total weight of polyalkylsiloxane compounds.

In some examples, the step of generating on the intermediate transfer member a print image comprises printing an ink composition onto a photo-imaging cylinder to generate a developed toner image or print image and transferring the developed toner image or print image onto the intermediate transfer member. In some examples, the step of generating on the intermediate transfer member a print image comprises printing an ink composition directly onto the intermediate transfer member to generate a developed toner image or print image. In some examples, the ink composition is a liquid electrophotographic ink composition or an inkjet ink composition. In other words, the method of digital offset printing may be a liquid electrophotographic printing method using a liquid electrophotographic ink composition, or a transfer inkjet printing method using an inkjet ink composition.

In some examples, the developed toner or print image is at least partially dried and fused on the intermediate transfer member. The drying and fusing step may be facilitated by heating of the intermediate transfer member and/or a stream of heated air directed to the surface of the intermediate transfer member having the developed toner image thereon. As a final step, the dried and fused print image is transferred to a print substrate. Any suitable substrate may be used, and may comprise a paper substrate, a paperboard substrate, a polymer film, or a metallized version of the aforementioned substrates.

### EXAMPLES

The following illustrates examples of the methods and other aspects described herein. Thus, these Examples should not be considered as limitations of the present disclosure, but are merely in place to teach how to make examples of the present disclosure.

### Materials

Primer G [(3-Glycidoxypropyl)trimethoxysilane; available from ABCR GmbH]:

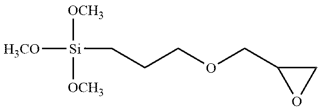 [SMILES: CO[Si](CCCOCC1CO1)(OC)OC]

V3E (vinyltriethoxysilane; available from ABCR GmbH):

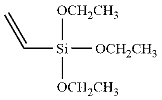

Tyzor AA-75 (75 wt.% in isopropanol; available from ABCR GmbH)

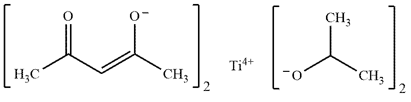

Karstedt’s catalyst (platinum divinyl tetramethyl disiloxane complex; 9 wt.% in isopropanol; purchased from Johnson Matthey and used as received):

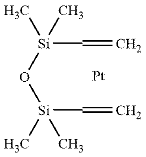

Catalyst 510 (0.5% platinum in isopropanol; available from Evonik Hanse GmbH):

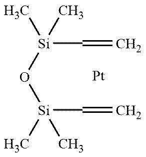

FMV-4035 (vinyl-terminated trifluoropropylmethylsiloxane-dimethylsiloxane copolymer in which 35 mol% to 45 mol% is derived from trifluoropropylmethylsiloxane units with an average molecular weight of 6000 g/mol to 9000 g/mol and a kinematic viscosity of 4000 cSt to 6000 cSt (about 0.004 m²/s to about 0.006 m²/s), available from Gelest Inc.).

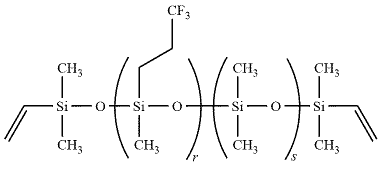

Polymer VS500 (vinyl-terminated polydimethylsiloxane; available from Evonik Hanse GmbH):

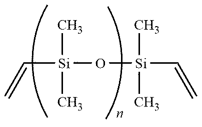

Polymer RV 5000 (pendent vinyl polydimethylsiloxane, viscosity 3000 cps; available from Evonik Hanse GMBH):

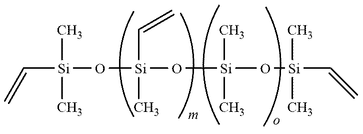

in which m is 1 or more and o is 0 or more

Cross-linker 210 (CL210; a polydimethylsiloxane containing at least two Si-H bonds; available from Evonik Hanse GmbH):

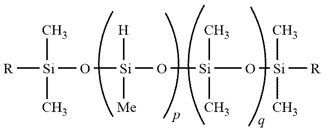

in which R = Me, p is 2 or more; and q is 0 or more.

Inhibitor 600 (an alkinol in Polymer VS; available from Evonik Hanse GmbH).

Carbon Black: Ketjenblack® EC600JD from AkzoNobel.

Silwet L-77 (available from Momentive): a trisiloxane containing a low molecular weight polyether group.

### Preliminary Examples 1 to 6

In preliminary experiments aiming to determine the optimal hydride/vinyl mole ratio for complete curing of the curable silicone release formulation, FMV-4035 (40 wt.% of the total amount of vinyl-containing polyalkylsiloxane compounds; 50 g) was added to a 2:1 mixture of Polymer VS500 and Polymer RV5000 (50 g of Polymer VS500 (40 wt.% of the total amount of vinyl-containing polyalkylsiloxane compounds and 25 g or Polymer RV5000 (20 wt.% of the total amount of vinyl-containing polyalkylsiloxane compounds)). To this mixture was added increasing amounts of the Cross-linker 210 (CL210) to obtain a hydride/vinyl mole ratio ranging from 0.4 to about 6.8. The amount of thermal inhibitor (Inh600; 12.5 g) and catalyst (CAT510; 1.25 g) in these experiments was fixed at 5 wt.% and 0.5 wt.%, respectively. Table 1 summarizes the percentage swelling and percentage leaching shown for increasing hydride/vinyl mole ratios.

TABLE 1

Test results on addition cured silicones made from a 2:3 weight ratio of FMV-4035 to a mixture of Polymer VS 500 and Polymer RV5000 (at a 2:1 weight ratio) with variable hydride to vinyl mole ratios.

| Prelim. Ex. | CL210 (g) | Hydride/vinyl mole ratio | Calculated wt.% F in silicone | Swelling [%] | Leaching [%] |
|---|---|---|---|---|---|
| 1 | 3.035 | 0.42 | 8.31 | 201 ± 2 | 3.4 ± 0.1 |
| 2 | 6.07 | 0.84 | 8.11 | 100 ± 1 | 3.1 ± 0.1 |
| 3 | 12.14 | 1.68 | 7.75 | 103 ± 1 | 6.4 ± 0.2 |
| 4 | 17.05 | 2.36 | 7.47 | 105 ± 1 | 5.0 ± 0.6 |
| 5 | 24.35 | 3.37 | 7.10 | 108 ± 1 | 2.6 ± 0.3 |
| 6 | 48.63 | 6.73 | 6.09 | 142 ± 1 | 19.2 ± 0.4 |

With a relatively low hydride/vinyl mole ratio of ca. 0.42 (Example 1, Table 1), the obtained silicone exhibits a relatively high percentage swelling in Isopar L (approximately 200%). Increasing the hydride/vinyl mole ratio to within the range of from 0.84 to about 3.37 (Examples 2 to 5, Table 1) results in swelling in Isopar L in the range of 100-110%. At a hydride/vinyl mole ratio of 6.7 (Example 6, Table 1), swelling in Isopar L was about 140% but with a relatively high percentage of leaching of about 19%. The amount of leaching often reflects the amount of silicone that did not polymerize during curing and as a rule of thumb any release layer with leaching greater than 5% is less effective than those showing lower leaching. To summarize, hydride/vinyl mole ratio in the range of from about 0.8 to about 3.4 was chosen for further study. At this mole ratio range, the percentage swelling is about 100±10% with an average percentage leaching of <5%.

### Primer

Primer G (300 parts) was added to V3E (200 parts). The mixture was stirred gently using a magnetic stirrer and Tyzor AA-75 (10 parts, 2 wt.%) was added dropwise to the mixture. The mixture was stirred for 4 hours under ambient conditions. Prior to coating, Karstedt’s catalyst (3 wt.% based on total mass) was added and the mixture was stirred for an additional 10 minutes at room temperature (about 22° C.). When kept sealed, this reactive primer must be used in an ITM blanket coating within 2 hours.

### Comparative Example 1

Carbon black (0.8 wt.% based on total silicone mass) was suspended in a mixture of a vinyl-terminated polydimethylsiloxane (polymer VS500; viscosity: 500 mPa·s) and a pendent vinyl polydimethylsiloxane (polymer RV5000; viscosity: 3,000 mPa·s) at a weight ratio of 4:1 (VS500 to RV5000) and the mixture was allowed to stand at room temperature for 2 hours. The mixture was then homogenised under high shear mixing (6,000 rpm) for 3 minutes. This concentrate (the master batch) was kept sealed until used. A polydimethylsiloxane cross-linker containing at least two Si-H bonds (CL210; 10 parts) and a thermal inhibitor (Inhibitor 600; 5 parts) were added to the master batch (100 parts). The mixture was then homogenised (3,000 rpm, 1 min) and left to stand until used. Just prior to coating the curable release formulation on an intermediate transfer member blanket, Catalyst 510 (0.5 parts) was added and the resulting mixture was homogenised (3,000 rpm, 3 min). This mixture is stable for a few hours when kept sealed but it is preferably used just after addition of the catalyst.

### Comparative Examples 2 and 3 and Examples 4 and 5

Carbon black (1 parts per hundred (phr) based on total silicone mass) was suspended in isopropyl alcohol (125 g, 20 phr based on total silicone). To this mixture was added Silwet L-77 (0.8 phr) and the mixture was stirred with a magnetic stirrer for 3 hours. A viscous cake was obtained, indicating a good dispersion is formed. A mixture of a vinyl-terminated polydimethylsiloxane (polymer VS500; viscosity: 500 mPa·s) and a pendent vinyl polydimethylsiloxane (polymer RV5000; viscosity: 3,000 mPa·s) at a weight ratio of 4:1 (VS500 to RV5000, see Table 2 for amounts) was added to the viscous cake. To this mixture was then added a partially fluorinated polyalkylsiloxane containing two vinyl groups (FMV-4035, see Table 2 for amounts). This concentrate (the master batch) was kept sealed until used. Just prior to coating the curable release formulation on an intermediate transfer member blanket, a thermal inhibitor (Inhibitor 600, 31.25 g, 5 phr on total silicone) and a polydimethylsiloxane cross-linker containing at least two Si-H bonds (CL210; 50 g, 10 phr on total silicone) were added to the master batch and the mixture was further homogenised (3,000 rpm, 3 min). Finally Catalyst 510 (3.125 g, 0.5 phr on total silicone) was added and the curable silicone release formulation was homogenised at 3,000 rpm for 1 min. This mixture is stable for about 2 hours when kept sealed but it is preferably used just after addition of the catalyst.

TABLE 2

Examples and Comparative Examples

| | VS500 [wt.%]* | RV5000 [wt.%]* | FMV-4035 [wt.%]* | CL210 [g] | Hydride/vinyl mole ratio | Calculated wt.% of F in silicone |
|---|---|---|---|---|---|---|
| Comp. Ex. 1 | 80 | 20 | - | 10 | 2.1 | 0 |
| Comp. Ex. 2 | 63.33 | 31.67 | 5 | 10 | 2.0 | 0.98 |
| Comp. Ex. 3 | 60 | 30 | 10 | 10 | 1.9 | 1.94 |
| Ex. 4 | 53.33 | 26.67 | 20 | 10 | 1.8 | 3.87 |
| Ex. 5 | 40 | 20 | 40 | 10 | 1.7 | 7.75 |

* Weight percentages are given as a percentage of the amount of vinyl-terminated polydimethylsiloxane (VS500), pendant vinyl polydimethylsiloxane (RV5000) and partially fluorinated polyalkylsiloxane (FMV-4035).

Additionally, tests were also performed in which FMV-4035 was combined with a 4:1 ratio of VS500 and RV5000. The intermediate transfer members produced by using this formulation produced a softer intermediate transfer member with a higher percentage swelling in Isopar L. It is believed that this higher swelling is caused by the reduction in the number of vinyl groups in the composition as a result of the fact that FMV-4035 contains terminal vinyl groups, whereas RV5000 contains a mixture of terminal and pendent vinyl groups. Thus, to increase the number of vinyl groups present, a higher amount of RV5000 was used (a 2:1 ratio of VS500 and RV50000).

### Preparation of the Intermediate Transfer Member With the Cured Silicone Release Layer

An intermediate transfer member body was selected. For one-shot web presses, a CSL160/25 (an ITM body with a compliant soft layer having a thickness of 160 µm and a Shore A hardness after curing of 25, referred to as Iris) is selected (available from Coveris®). For a sheet-fed press, a CSL80/40 (an ITM body with a compliant soft layer having a thickness of 80 µm and a Shore A hardness after curing of 40, referred to as Gemini 3) is selected (available from Coveris®). The intermediate transfer member body comprises an uncured compliant soft layer, which is cured at the same time as the curable silicone release formulation. The curable silicone release formulation was applied on a blanket production line using a continuous set of gravure coating stations at a constant coating speed of 5 m/min. For the adhesion of the curable silicone release layer on the CSL, the primer (described above) was applied to an intermediate transfer member body by using a 10.5 cm²/m³ gravure roller. Immediately thereafter, the curable silicone release formulation was applied by using a 13.8 cm²/m³ gravure roller. Three dryers, set at 90° C., were used to cure the curable silicone release formulation. For full curing (including full curing of the compliant soft layer), the intermediate transfer member was then incubated in a curing oven at a temperature of 120° C. for a period of 1.5 hours.

TABLE 3

Results of swelling, leaching and adhesion tests for partially fluorinated silicone release layers with increasing amounts of partially fluorinated polyalkylsiloxane included.

| | Swelling [%] | Leaching [%] | Adhesion (out of 4) |
|---|---|---|---|
| Comp. Ex. 1 | 117 ± 2 | 2.7 ± 0.1 | 4 |
| Comp. Ex. 2 | 115 ± 1 | 2.7 ± 0.1 | 4 |
| Comp. Ex. 3 | 107 ± 1 | 2.8 ± 0.1 | 4 |
| Ex. 4 | 100 ± 1 | 2.6 ± 0.1 | 4 |
| Ex. 5 | 105 ± 1 | 6.4 ± 1.0 | 2 |

Although Example 5, containing 40 wt.% of the partially fluorinated polyalkylsiloxane (FMV-4035) as a proportion of the polyalkylsilxane comprising vinyl groups did not adhere well to the intermediate transfer member body, the swelling and leaching results suggest that such a release layer would provide improved properties to the intermediate transfer member if a different primer is used to improve the adhesion to the intermediate transfer member body.

### Printing Test Results

Tests were performed on a Ser III web press to compare the printing performance of the intermediate transfer member blanket produced in Example 4 (incorporating 20 wt.% partially fluorinated polyalkylsiloxane) with Comparative Example 1 (containing 0 wt.% partially fluorinated polyalkylsiloxane). For this typical experiment, we used Timna fabric adhesive layer that was laminated with compliant soft layer (CSL) of 80 µm and a shore A hardness of 40. In a typical 80 K press test, print quality monitors (small dots, gray60, cleaners, etc.) were taken every 6 K impressions using mainly coated Condat paper (110 g/m²). At the end of each experiment, the media was replaced with a wine label (200 g/m²) for conformability assessment. Wine labels are very rough and challenging substrates for liquid electrophotographic printing and passing this conformability test shows that an intermediate transfer member blanket is suitable for use in liquid electrophotographic printers. ITM blankets containing 5 wt.% and 10 wt.% FMV-4035 (Comparative Examples 2 and 3) resulted in almost identical print quality results when compared to Comparative Example 1. Results showed no differences or minor differences for all print quality monitors including small-dots (SD), negative-dot-gain (NDG), and background-on-blanket (BOB) tests, to name a few (data not shown). Also, no differences were noticed in the conformability test results with the wine label (data not shown). It is believed that the similarities in performance between Comparative Example 1 and the ITM blankets with 5 wt.% and 10 wt.% FMV-4035 (Comparative Examples 2 and 3) is due to the fact that the amount of partially fluorinated polyalkylsiloxane is too low to make a significant difference in the properties of the release layer. It is very important to emphasize that even though the amount of FMV-4035 is about 10 wt.% based on the total amount of polyalkylsiloxane, the amount of trifluoropropylmethylsiloxane units is less than half of that number as FMV-4035 exhibits only between 35 mol% and 45 mol% trifluoropropylmethylsiloxane groups.

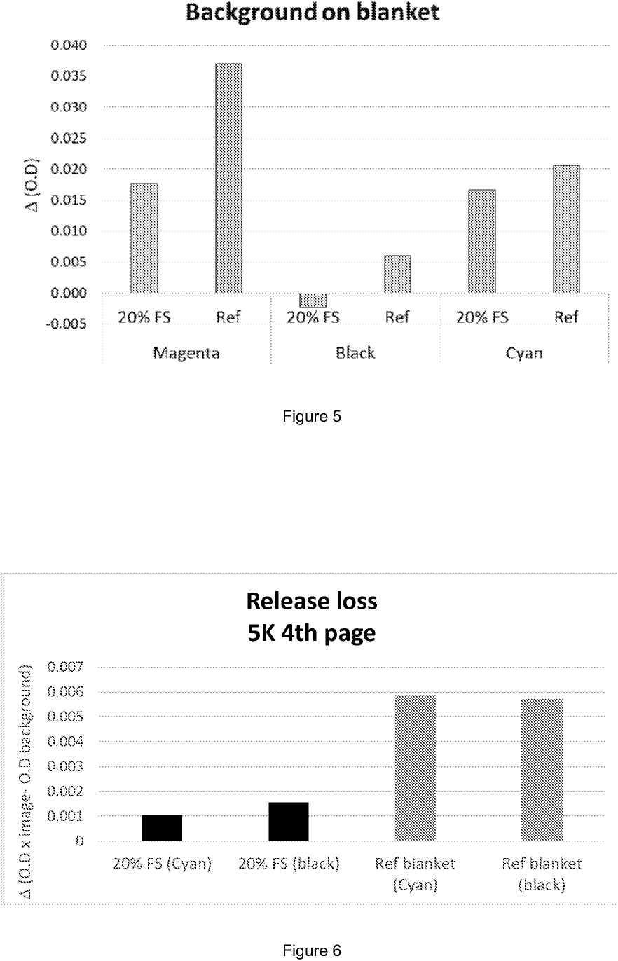

FIG. 5 shows the impact (and improvement) of incorporating 20 wt.% partially fluorinated polyalkylsiloxane on typical print quality failures associated with liquid electrophotographic printing. A significant improvement in background on blanket (BOB) print quality issues (at 48 K impressions) was observed with the ITM blanket containing 20 wt.% FMV-4035 (Example 4) over the reference without the partially fluorinated polyalkylsiloxane (Comparative Example 1). FIG. 5 shows the improvement in BOB (on a sheet-fed press) of the Example 4 ITM blanket (20% FS) relative to the Comparative Example 1 ITM blanket (Ref) as a function of LEP ink colour. For magenta and black ink the improvement in BOB was more significant than for cyan ink. In addition to improvements in BOB results, the Example 4 ITM blanket showed some reduction in negative dot gain (NDG). The improvement in NDG, however, is not as significant as the improvement in in the BOB results.

FIG. 6 shows results from a typical release loss test. A typical release-loss test is achieved by blanket aging (~5K impressions) via repeatedly printing small squares having different coverages. Immediately after this, a copy of gray60 is printed on uncoated Soporset paper followed by a yellow cleaner layer on coated paper. As the uncoated Soporset paper exhibits a relatively low ink transfer, residual ink on the ITM blanket (i.e. ink that has not been efficiently transferred from the blanket to the uncoated Soporset media) is picked up with the cleaner ink layer that follows. Therefore, the more ink the yellow cleaner layer collects, the greater the release loss of the blanket. From previous release loss experiments, black color ink (100% K) has been proven to be the most easily observed on a yellow background; therefore, release loss failure focuses on areas with 100% K coverage during blanket aging. Results of this test show that for the Example 4 ITM blanket, residual ink can barely be seen, indicating that this ITM blanket shows no to negligible release loss after 5 K impressions. In contrast, the intensity of residual ink on the Comparative Example 1 ITM blanket is stronger than that on the Example 4 ITM blanket, indicating more significant release loss for the Comparative Example 1 ITM blanket. The improved releaseability of the ITM blanket (i.e., the decrease in loss of releaseability) of the partially fluorinated polyalkylsiloxane containing ITM blanket may be due to the chemical nature of the fluorosiloxane groups which exhibit improved release properties over the Comparative release layer (i.e. without fluoro-containing groups in the polymer backbone). In addition, fluorosiloxane groups exhibit improved chemical stability towards plasma etching, which is thought to occur during the 1^{st} transfer of ink (i.e., the transfer of ink from the photoimaging plate (PIP) to the ITM blanket). As a result, the ITM blanket maintains release properties over a longer period compared to previous silicone release layers which are highly vulnerable to plasma etching. FIG. 6 shows the improvement in release loss calculated by subtracting the optical density of the former background areas from the optical density of the former image areas (Δ(O.D. x image - O.D. x background).

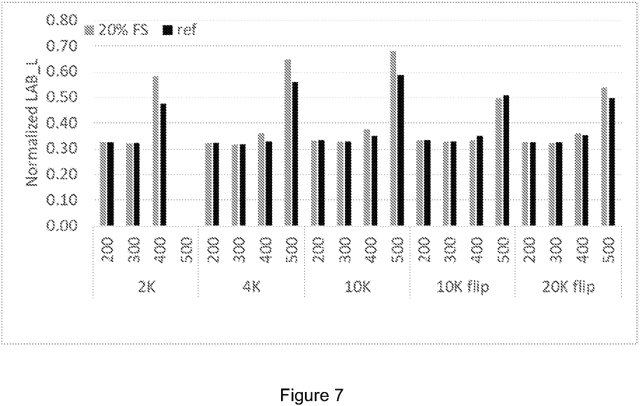

Conformability test results are shown in FIG. 7. In this test, an ITM blanket are created in which one half of the release layer is made from the curable silicone release formulation of Example 4 (20% FS) and the other half of the release layer is made from the curable silicone release formulation of Comparative Example 1. This ITM blanket was tested for the ability to transfer ink under stress conditions. For both halves of the ITM blanket, a Gemini sheet-fed ITM body with a CSL80/40 compliant soft layer was used as the ITM body onto which the curable silicone release formulation was applied. The thickness of used substrate used (Century paper) was 300 µm. In the printing press settings, the substrate thickness was manipulated between thicknesses of 200 µm and 500 µm. Thus, at printing press settings of 200 µm substrate thickness, the transfer of ink from the ITM blanket to the substrate (the T2 transfer; in Kg force) is higher than for printing press settings of 300 µm (i.e., normal settings for Century paper). However, at printing press settings 400 µm and 500 µm, the press is “deceived” and the less force is applied during T2; thus, ink transfer is deteriorated. Normalized LAB_L values were calculated for each half of the printed substrate. Low LAB_L values indicate areas that have a thicker layer of black ink on the substrate; thus, the lower the LAB_L value, the better the ink transfer. It is clear from FIG. 7 that the difference between in conformability performance between the Example and Comparative Example release layers is negligible. This is not surprising as conformability is mostly influenced by the compliant soft layer (CSL) and not by the release layer. However, the purpose of this experiment was to show that the presence of the partially fluorinated polyalkylsiloxane neither deteriorated nor improved the conformability. As expected, flipping the blanket in the press, that is, switching the Example and Comparative Example release layers between the front and rear sides of the ITM, did not influence performance.

### Negative-Dot-Gain (NDG) Tests

Dot gain memory is defined by a 1% to 5% difference in dot size between ex-image and ex-background areas on an ITM blanket. Dots in ex-Image areas appear smaller in size than in ex-background areas. Several factors are believed to cause NDG such as dynamic diffusion due to fast swelling on ex-image areas relative to ex-background areas, release properties, electrical differences, and elasticity of the release layer, to name a few. Dot gain is measured via an X-rite machine by using the function called “Dot gain”. The default for dot gain calculations is the Murray-Davies function which calculates dot gain by comparing the density of the printed ink minus paper with the density of the solid minus paper.

The Murray-Davies formula for calculating Dot gain is:

$$\text{Apparent} \text{dot} \text{area} = \frac{1 - {10}^{- {D}_{d}}}{1 - {10}^{- {D}_{s}}} \times 100$$

Wherein Dₜ is the density of printed ink minus the density of paper; and Dₛ is the density of solid minus the density of paper.

To perform dot measurements:
1. Measure the density of blank paper
2. Measure the density of 100% solid black ink printed on the paper
3. Measure tint patch (print - different gray level) that corresponds to the measured solid.
4. Measurement data first appears as density and is converted by the software to either the dot area percentage or dot gain percentage difference.

### Background on Blanket Test

In this text, the amount of ink accumulated on the background areas of the ITM blanket is measured after 400 impressions. Normally, the accumulation of ink in the background areas on the blanket after 400 impressions should be <0.005 OD units.

### Release Loss Tests

Release loss is a deterioration of the ability of the ITM blanket to transfer ink to substrates in ex-image areas. This failure is known to be influenced by the ink components, process parameters, substrate, and release layer formulation.

### Adhesion Test of the Cured Silicone Release Layer

In a typical adhesion test, Isopar L was added on top of a region of the cured silicone release layer and allowed to stand for at least one minute. Excess Isopar L was wiped away using a nonwoven polyester/cellulose paper (Essential wipes, from Essentra). Adhesion was measured by applying force (by hand) and aggressive rubbing (15 times in each direction) on the region with a dry nonwoven wiping paper that has been folded three times. The extent of adhesion was visually evaluated by rating the visible damage from 1 to 4, where 1 represents a complete failure and total peel-off, 2 represents considerable damage, 3 represents minor visible damage, and 4 represents no damage.

### Conformability Test

Conformability is the ability of the ITM blanket to transfer the image to rough substrates (e.g. wine labels). The CSL (compliant soft layer), which is located beneath the cured silicone release layer, is the most crucial layer which adapts itself to the topography of the targeted substrate. The CSL used in a sheet-fed printing press is a soft layer with a thickness of 80 µm and Shore A hardness of 40 (referred to as CSL80/40). On the other hand, the CSL used in web presses (i.e. one-shot printing presses) is made from a soft layer with a thickness of 160 µm and a Shore A hardness of 25 (referred to as CSL160/25).

### Calculation of Percentage Swelling

The percentage swelling is calculated by using the following equation:

$$\text{percentage} \text{swelling} = \frac{{W}_{s} - {W}_{0}}{{W}_{0}} \times 100$$

wherein wₛ is the weight of the swollen specimen and w₀ is the weight of the dry specimen prior to the swelling test.

The percentage swelling defines the amount of Isopar L uptake for a particular silicone release formulation. In a typical swelling test, a specimen of a curable silicone release formulation (approximately 5 g) is cured in an aluminium dish at 120° C. for at least 2 hours to form a cured silicone release formulation. The specimen of cured silicone release formulation is weighted and then the cured silicone release formulation is placed in a glass bottle of Isopar L (100 g) and the glass bottle is sealed and heated in an oven at 100° C. for 10 h. After cooling the sample to room temperature (about 22° C.), the specimen of cured silicone release formulation is removed and Isopar L on the surface of the specimen is dried with non-woven paper before the sample is weighed for the calculation of the percentage swelling as defined above.

### Calculation of Percentage Leaching

The percentage leaching is calculated by using the following equation:

$$\text{percentage} \text{leaching} = \frac{{W}_{d} - {W}_{0}}{{W}_{d}} \times 100$$

wherein w_{d} is the weight of the dried silicone specimen after swelling and w₀ is the weight of the dry silicone specimen prior to the swelling test.

The percentage leaching measures the amount of unreacted silicone chains that are lost from the silicone specimen during swelling. During curing of the curable silicone release formulation, not all of the polymer chains undergo the curing reaction. There are many reasons that some polymer chains do not react (for example, low diffusion and high viscosity). However, regardless of the curing method, the degree of curing for a cured silicone release layer of an intermediate transfer member is preferably above 95 wt.%. Additionally, cured silicone release layers with greater than 5% leaching are less suitable for use in an intermediate transfer member.

### Calculation of Wt.% Fluorine in Silicone

FMV-4035 is a (trifluoropropyl)methylsiloxane-dimethylsiloxane copolymer in which 35 to 45 mol% of the copolymer is the (trifluoropropyl)methylsiloxane repeating unit. For simplicity, in calculating the weight percentage of fluorine in silicone, it has been assumed that an average of 40 mol% (trifluoropropyl)methylsiloxane is present in the mixture.

The weight percentage of the fluorine containing repeating unit in the copolymer is calculated by the equation:

$$\frac{\frac{\text{mol} \% F}{100} \times {M}_{w} \left(F\right)}{\frac{\text{mol} \% H}{100} \times {M}_{w} \left(H\right) + \frac{\text{mol} \% F}{100} \times {M}_{w} \left(F\right)} \times 100$$

wherein
mol%F = the molar percentage of the fluorine containing siloxane repeating unit
M_{w}(F) = the molecular weight of the fluorine containing siloxane repeating unit.
mol%H = the molar percentage of the unfluorinated siloxane repeating unit
M_{w}(H) = the molecular weight of the unfluorinated siloxane repeating unit

In FMV-4035, the fluorine containing siloxane repeating unit is (trifluoropropyl)-methylsiloxane (M_{w}(F) = 156.18 g/mol) and the un-fluorinated siloxane repeating unit is dimethylsiloxane (M_{w}(H)=74.15 g/mol).

Thus, the weight percentage of fluorine containing siloxane repeating units is:

$$\frac{\frac{40}{100} \times 156.18}{\frac{60}{100} \times 74.15 + \frac{40}{100} \times 156.18} \times 100 = 58.5 \text{wt} \text{.} \%$$

The weight percentage of fluorine atoms in the fluorine containing repeating unit of the copolymer is calculated by the equation:

$$\frac{\text{weight of F atoms in the fluorine containing repeating unit}}{\text{weight of the fluorine containing repeating unit}} \times 100$$

In FMV-4035, the weight percentage of fluorine atoms in the fluorine containing repeating unit of the copolymer = (19x3)/156.18x100 = 36.5 wt.%.

The weight percentage of fluorine atoms in the at least partially fluorinated polyalkylsiloxane is calculated by the equation:

$$\left(\text{wt} \text{.\% F atoms}\right) \times \left(\text{wt} \text{.\% fluorine containing siloxane repeating units}\right)$$

Thus, in FMV-4035, the weight percentage of fluorine atoms in the copolymer is

$$\frac{36.5}{100} \times \frac{58.5}{100} \times 100 = 21.35 \text{wt} \text{.\%}$$

To calculate the weight percentage of fluorine atoms in a mixture of two polymers, the weight percentage of fluorine atoms in the fluorinated polymer is multiplied by the weight percentage of the fluorinated polymer in the composition.

Thus, for a curable silicone release formulation containing 5 wt.% FMV-4035 and 95 wt.% of a mixture of VS500 and RV5000, the weight percentage of fluorine atoms in the vinyl-containing polyalkylsiloxane mixture is 21.35 x (5 /100) ≈ 1.1 wt.%.

Finally, the cross-linker is present in the curable silicone release formulation in an amount of approximately 10 wt.% and thus, the final weight percentage of fluorine atoms in the polyalkylsiloxane is calculated as follows: 1.1 wt.% * 100/110 ≈ 1 wt.% -when additional decimal places are considered throughout this calculation, this value is 0.98 wt.% as reported above in Table 2.

While the invention has been described with reference to certain examples, those skilled in the art will appreciate that various modifications, changes, omissions, and substitutions can be made without departing from the spirit of the disclosure. It is intended, therefore, that the invention be limited by the scope of the following claims. Unless otherwise stated, the features of any dependent claim can be combined with the features of any of the other dependent claims and any of the independent claims.

1. An intermediate transfer member for digital offset printing, comprising:
a cured silicone release layer formed by curing a curable silicone release formulation comprising:
a polyalkylsiloxane containing at least two vinyl groups;
an at least partially fluorinated polyalkylsiloxane containing at least two vinyl groups;
a polyalkylsiloxane cross-linker containing at least two Si-H bonds; and
a catalyst or photoinitiator;
wherein fluorine atoms provide at least 2.5 wt.% of the total weight of polyalkylsiloxane compounds.

2. The intermediate transfer member according to claim 1, wherein fluorine atoms provide up to 10 wt.% of the total weight of polyalkylsiloxane compounds.

3. The intermediate transfer member according to claim 1, wherein the at least partially fluorinated polyalkylsiloxane containing at least two vinyl groups comprises a vinyl-terminated at least partially fluorinated polyalkylsiloxane having the following formula: 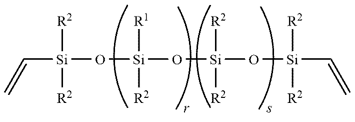
wherein
R¹ is a partially fluorinated alkyl group;
each R² is independently an alkyl group;
r is 1 or more; and
s is 0 or more.

4. The intermediate transfer member according to claim 3, wherein R¹ is selected from fluorinated C1 to C6 alkyl groups comprising at least 1 fluorine atom.

5. The intermediate transfer member according to claim 3, wherein R¹ is selected from fluorinated C1 to C6 alkyl groups comprising three fluorine atoms.

6. The intermediate transfer member according to claim 3, wherein R¹ is trifluoropropyl.

7. The intermediate transfer member according to claim 3, wherein each R² is independently selected from C1 to C6 alkyl groups.

8. The intermediate transfer member according to claim 3, wherein r is at least about 30% of (r + s).

9. The intermediate transfer member according to claim 3, wherein r is up to about 60% of (r + s).

10. The intermediate transfer member according to claim 1, wherein the polyalkylsiloxane containing at least two vinyl groups comprises a vinyl-terminated polyalkylsiloxane having the following formula: 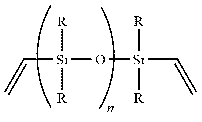
wherein
each R is independently selected from C1 to C6 alkyl; and n is 1 or more.

11. The intermediate transfer member according to claim 1, wherein the polyalkylsiloxane containing at least two vinyl groups comprises a pendent vinyl polyalkylsiloxane having the following formula: 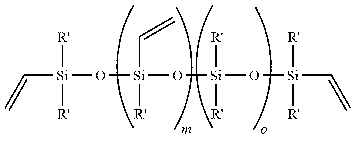
wherein
each R′ is independently selected from C1 to C6 alkyl;
m is 1 or more; and
o is 0 or more.

12. The intermediate transfer member according to claim 1, wherein the polyalkylsiloxane containing at least two vinyl groups comprises a mixture of a vinyl-terminated polyalkylsiloxane and a pendant vinyl polyalkylsiloxane, wherein the vinyl-terminated polyalkylsiloxane has the following formula: 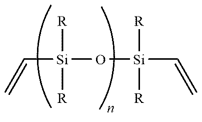
wherein
each R is independently selected from C1 to C6 alkyl; and n is 1 or more; and
wherein the pendent vinyl polyalkylsiloxane has the following formula: 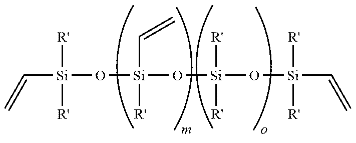
wherein
each R′ is independently selected from C1 to C6 alkyl;
m is 1 or more; and
o is 0 or more.

13. The intermediate transfer member of claim 1, wherein the polyalkylsiloxane cross-linker comprising at least two Si-H bonds comprises a polyalkylsiloxane cross-linker having the following formula: 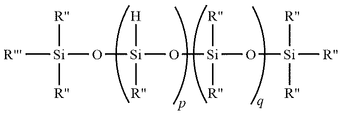
wherein
each R″ is independently selected from C1 to C6 alkyl;
each R‴ is independently selected from H and C1 to C6 alkyl;
p is 2 or more; and
q is 0 or more.

14. A method of producing an intermediate transfer member for digital offset printing, comprising:
applying onto an intermediate transfer member body a curable silicone release formulation;
curing the curable silicone release formulation to form a cured silicone release layer;
wherein the curable silicone release formulation comprises:
a polyalkylsiloxane containing at least two vinyl groups;
an at least partially fluorinated polyalkylsiloxane containing at least two vinyl groups;
a polyalkylsiloxane cross-linker containing at least two Si-H bonds; and a catalyst or photoinitiator;
wherein fluorine atoms provide at least 2.5 wt.% of the total weight of polyalkylsiloxane compounds.

15. A curable silicone release formulation for an intermediate transfer member of a digital offset printing apparatus, comprising:
a polyalkylsiloxane containing at least two vinyl groups;
an at least partially fluorinated polyalkylsiloxane containing at least two vinyl groups;
a polyalkylsiloxane cross-linker containing at least two Si-H bonds; and
a catalyst or photoinitiator;
wherein fluorine atoms provide at least 2.5 wt.% of the total weight of polyalkylsiloxane compounds.
